(19) United States
(12) Patent Application Publication
(10) Pub. No.: US 2025/0272122 A1
(43) Pub. Date: Aug. 28, 2025

(54) External Application Streaming

(71) Applicant: GOOGLE LLC, Mountain View, CA (US)

(72) Inventors: Jesse Johnston, San Jose, CA (US); Tyler Kugler, Mountain View, CA (US); Russell Matsuo, San Francisco, CA (US); Shiba Sheikh, San Francisco, CA (US)

(21) Appl. No.: 18/858,414

(22) PCT Filed: May 8, 2023
(86) PCT No.: PCT/US2023/021297

§ 371 Date: Oct. 21, 2024

Related U.S. Application Data
(60) Provisional application No. 63/340,226, filed on May 10, 2022.

(51) Int. Cl. G06F 9/451; G06F 3/04817; G06F 3/0482; H04W 76/19

(52) U.S. Cl. CPC G06F 9/452; G06F 3/04817; G06F 3/0482; H04W 76/19

(57) ABSTRACT

The technology provides a system capable of pairing, via at least one wireless connection, a first client device (102,602) to a second client device (302,604), allowing the client devices to directly communicate; generate, by one or more processors of the second client device (402), and communicate, via the at least one wireless connection, an encoded virtualized remote display of an application where the application is running on the second client computing device (302,604); streaming the application on the first client device (102,602) including presenting on a graphical user interface (GUI) (106,1200,1900,2300,2500) a virtualized remote display (1502,1902,2302), based on an encoded virtualized remote display, of the application on the first client device (102,602) to enable a user of the first client device (102,602) to control the application running on the second client device (302,604).

### CROSS-REFERENCE TO RELATED APPLICATIONS

This application claims the benefit of the filing date and priority to U.S. Provisional Patent Application No. 63/340,226, filed May 10, 2022, the entire disclosure of which is incorporated herein by reference.

### BACKGROUND

In a system, multiple devices may be networked together in order to allow users to access features of differing devices throughout the system. Such access may have limited functionality due to incompatibility across differing types of devices. For example, programs designed to operate on one device or platform may not be able to operate smoothly on a differing device or platform. Even if a program is capable of running on multiple platforms, a technical problem may be that some functionality is lost due to incompatible user interfaces.

### BRIEF SUMMARY

Aspects of the technology provide a technical solution that enables application streaming from one computing device to a different computing device. By way of example, this includes wireless streaming of messaging apps such as a chat or texting app from a user's mobile phone (e.g., a second client computing device) to their laptop (e.g., a first client computing device). Many other configurations are possible with different client devices. The graphical user interfaces (GUIs) on the different client devices can help support a seamless user experience (UX), which promotes more effective and efficient communication between the user and others. The second client computing device may create an encoded virtualized remote display for an app it is currently running. This encoded virtualized remote display is sent to the first client computing device, where a virtualized remote display based on the encoded virtualized remote display is presented via a GUI of that device. The virtualized remote display at the first device, which need not present the same information as what is shown in the GUI of the second device, can receive one or more user inputs that are relayed back to the first device. This provides a technical benefit by enabling control of the app without the user having to directly use the first device.

According to one aspect, a method comprises: pairing, via at least one wireless connection, a first client device to a second client device, wherein the pairing allows the first client device and the second client device to directly communicate; receiving, by one or more processors of the first client device, an encoded virtualized remote display of an application via streaming from the second client device, the encoded virtualized remote display generated by the second client device, and the application running on the second client device; and controlling, by the one or more processors of the first device, a graphical user interface (GUI) to present a virtualized remote display of the application based on the encoded virtualized remote display on the first client device, the virtualized remote display configured to enable a user of the first client device to control the application running on the second client device.

The method may further comprise: receiving, by the first client device, an indication for an event associated with the application running on the second client device; and generating, by the one or more processors of the first client device for presentation via the GUI based on the received indication, a notification regarding the event. Here, the notification may be actionable by the user of the first device such that upon receiving input from the user, the method further includes transmitting a signal to the second client device, in which the signal is configured to cause the second client device to perform an action associated with the application.

Alternatively or additionally, upon termination of the streaming of the application, the method may include causing an image of the virtualized remote display of the application to be cached. Here, upon termination of the streaming of the application, the method may include designating the application as one of a set of one or more recent applications, and generating, for presentation by the GUI of the first client device, a menu of the one or more recent applications. Alternatively or additionally, the method may further comprise the one or more processors of the first client device sending a signal to the second client device to terminate the stream upon determining that the first client device is no longer paired with the second client device.

Alternatively or additionally, the method may further comprise: causing, when the at least one wireless connection is not maintained, termination of the streaming after a period of time; re-establishing the at least one wireless connection between the first client device and the second client device; and causing resuming of the streaming following the re-establishing of the at least one wireless connection. Alternatively or additionally, the method may further include generating, via the GUI of the first client device, at least one of, an icon indicating the second client device and the first client device are paired, or an icon indicating the streaming of the application is occurring.

Alternatively or additionally, the at least one wireless connection may include a first wireless connection and a second wireless connection distinct from the first wireless connection. Here, the pairing occurs via the first wireless connection, and receiving the encoded virtualized remote display of an application via streaming occurs via the second wireless connection. In this case, the method may further comprise transmitting, by the first client device, one or more user inputs received in response to the virtualized remote display, to the second client device via the second wireless connection.

Alternatively or additionally, receiving the encoded virtualized remote display of the application via streaming includes decoding, by the one or more processors of the first client device, the encoded virtualized remote display of the application. Alternatively or additionally, the method may further comprise generating, via the GUI of the first client device, at least one prompt to facilitate pairing between the first client device and the second client device.

According to another aspect, an application streaming method comprises: pairing, via at least one wireless connection, a second client device to a first client device, wherein the pairing allows the first client device and the second client device to directly communicate; generating, by one or more processors of the second client device, an encoded virtualized remote display of an application running on the second client device; transmitting, via the at least one wireless connection, the encoded virtualized remote display of the application from the second client device to the first client device via streaming; receiving, by the second client device, one or more user inputs associated with the application based on presentation of the application via a virtualized remote display, based on the encoded virtualized remote display on the first client device; and taking, by the one or more processors of the second client device, an action associated with the application based on the received one or more user inputs.

The method here may further include, prior to the transmitting, the one or more processors of the second client device encoding the virtualized remote display of the application. Alternatively or additionally, taking the action associated with the application may include updating the encoded virtualized remote display of the application. Alternatively or additionally, this method may further comprise generating, by the one or more processors of the second client device, a graphical user interface (GUI) that includes at least one of a permissions prompt to facilitate the pairing, or an actual display of the application for presentation to a user. Here, the encoded virtualized remote display generated by the one or more processors of the second client device may have a different visual appearance than the actual display of the application.

Alternatively or additionally for this method, the encoded virtualized remote display may be generated by the one or more processors of the second client device when a display device of the second client device is in a sleep mode. Alternatively or additionally for this method, the encoded virtualized remote display may be generated by the one or more processors of the second client device while another application is presented on a display device of the second client device. Alternatively or additionally, this method may further comprise, in response to termination of the streaming, the one or more processors of the second client device caching an image of the virtualized remote display of the application. Alternatively or additionally, the at least one wireless connection may comprise a first wireless connection and a second wireless connection distinct from the first wireless connection. Here, the pairing may occur via the first wireless connection, and transmitting of the encoded virtualized remote display of the application from the second client device occurs via the second wireless connection.

According to a further aspect, a computing device is configured to stream applications from a remote device. The computing device comprises one or more processors, one or more user inputs operatively coupled to the one or more processors, and a communication module operatively coupled to the one or more processors. The communication module is configured to: facilitate pairing of the computing device with the remote device via at least one wireless connection, wherein the pairing allows the computing device and the remote device to directly communicate, and receive, via a stream, an encoded virtualized remote display of an application from the remote device, the application being run on the remote device. The one or more processors are configured to: generate a graphical user interface (GUI) to present the application, including presentation on the GUI virtualized remote display, based on the encoded virtualized remote display, of the application being run on the remote device; receive input associated with the virtualized remote display from the one or more user inputs; and transmit, via the communication module, information regarding the received input to the remote device in order to control the application on the remote device.

According to yet another aspect, a computing device is configured to stream applications to a remote device. The computing device comprises one or more processors, one or more user inputs operatively coupled to the one or more processors, and a communication module operatively coupled to the one or more processors. The communication module is configured to: facilitate pairing of the computing device with the remote device via at least one wireless connection, wherein the pairing allows the computing device and the remote device to directly communicate. The one or more processors are configured to: generate an encoded virtualized remote display of an application of the computing device, the application being run on the computing device; cause the communication module to transmit, via the at least one wireless connection, the encoded virtualized remote display of the application to the remote device via streaming; receive, from the remote device via the communication module, one or more user inputs associated with the application based on presentation of a virtualized remote display, based on the virtualized remote display, of the application on the remote device; and take an action associated with the application based on the received one or more user inputs.

### BRIEF DESCRIPTION OF THE DRAWINGS

FIG. 1 illustrates a client computing device in accordance with aspects of the technology.

FIG. 2 is a block diagram of a client computing device in accordance with aspects of the technology.

FIG. 3 illustrates a client mobile device in accordance with aspects of the technology.

FIG. 4 is a block diagram of a client mobile device in accordance with aspects of the technology.

FIGS. 5A-B illustrate systems for use with aspects of the technology.

FIG. 6 illustrates a system for use with aspects of the technology.

FIG. 7 illustrates an example prompt in accordance with aspects of the technology.

FIG. 8 illustrates an example prompt in accordance with aspects of the technology.

FIG. 9 illustrates an example prompt in accordance with aspects of the technology.

FIGS. 10A-B illustrate example prompts in accordance with aspects of the technology.

FIGS. 11A-B illustrate example prompts and connections in accordance with aspects of the technology.

FIG. 12A-B illustrate example scenarios in accordance with aspects of the technology.

FIG. 13 illustrates an example notification in accordance with aspects of the technology.

FIG. 14 illustrates an example scenario in accordance with aspects of the technology.

FIG. 15 illustrates an example stream in accordance with aspects of the technology.

FIG. 16 illustrates an example scenario in accordance with aspects of the technology.

FIG. 17 illustrates an example scenario in accordance with aspects of the technology.

FIG. 18 illustrates an example notification in accordance with aspects of the technology.

FIG. 19 illustrates an example stream in accordance with aspects of the technology.

FIG. 20 illustrates an example scenario in accordance with aspects of the technology.

FIG. 21 illustrates an example notification in accordance with aspects of the technology.

FIG. 22 illustrates an example notification in accordance with aspects of the technology.

FIG. 23 illustrates an example scenario in accordance with aspects of the technology.

FIG. 24 illustrates an example notification in accordance with aspects of the technology.

FIG. 25 illustrates an example scenario in accordance with aspects of the technology.

FIGS. 26A-B illustrate example scenarios in accordance with aspects of the technology.

FIGS. 27A-B illustrate example multi-touch interaction scenarios in accordance with aspects of the technology.

FIG. 28 illustrates an example method in accordance with aspects of the technology.

FIG. 29 illustrates an example method in accordance with aspects of the technology.

### DETAILED DESCRIPTION

The technology provides application streaming on one computing device (a first device) of a user from a different device (a second device) of that user. The user can control operation of the streamed app (e.g., a messaging app, streaming apps, social media, games, news, etc.) via a virtualized remote display that is presented via the GUI of the first device. The virtualized remote display may be based on an encoded virtualized remote display generated and sent from the second device. The encoded virtualized remote display may include encoded app content (e.g., audio, video, etc.). The encoder used by the second device may, for example, be an H.264 or MPEG-4 AVC encoder to ensure the quality of the streamed content. This approach addresses the technical problem of supporting a given app on different user devices, without the app having to be downloaded to or otherwise run on each device. In one scenario, the technical solution pairs the user devices via a communication link of a first type (e.g., a Bluetooth connection), while the streamed app and user instructions back to the second device are provided via a communication link of a second type (e.g., a WiFi or NFC connection). The virtualized remote display does not need to present the identical information as what is shown in the GUI of the second device, and in some instances the app can run on the second device in the background (or when the display of that device is off). In this regard, the virtualized remote display may provide a stylized view (e.g., view compatible with the GUI, inputs, etc. of the first device) or representation of an app on the GUI of the first device that more readily enables a user to control the app using inputs from the first device. The inputs are conveyed to the second device on which the virtualized remote display is generated. This provides a technical benefit by enabling control of the app without the user having to directly use the second device. In this regard, less bandwidth/overhead and smaller memory requirements may be needed in the control of the app as the stylized view or representation of the app is utilized instead of an identical copy of the GUI of the second device. As such, real time or near instantaneous control of the app on the second device using inputs from the first device may be supported.

### Example System

Unless otherwise stated, the disclosed examples and scenarios are not mutually exclusive, but may be implemented in various combinations to achieve unique advantages. As these and other variations and combinations of the features discussed above can be utilized without departing from the subject matter defined by the claims, the description of the implementations should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

### Example Computing Device

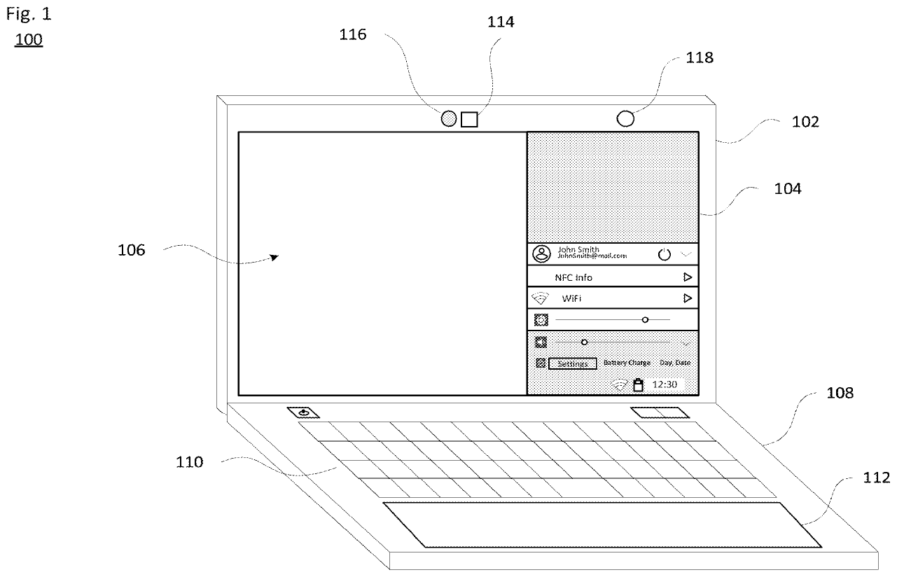

FIG. 1 illustrates an example 100 showing a client computing device 102, such as a laptop computer. In this example, there is a display 104 for visually presenting content via GUI 106, and a user input section 108 having a keyboard 110 and a trackpad 112 as different user inputs. A microphone (not shown) may be provided for audible input. The display 104 may be configured as a user input (e.g., a touchscreen). The keyboard 110 may be a virtual keyboard, for instance as part of another display. While one trackpad 112 is shown, the device may have two or more trackpads arranged thereon. The device may contain additional user inputs (e.g., a mouse, audio and/or gesture-based inputs).

An integrated webcam 114 can be used for videoconferences, interactive gaming, etc. Indicator 116, such as an LED, may be illuminated to alert a user whenever the integrated webcam is in use. The client device may also include one or more other sensors 118, which may be used to supplement visual information obtained by the webcam 114. By way of example, the one or more other sensors may include an additional imaging device, an RF- or ultrasonic-based motion sensor, such as to help identify gestures by the user or act as a human presence detector.

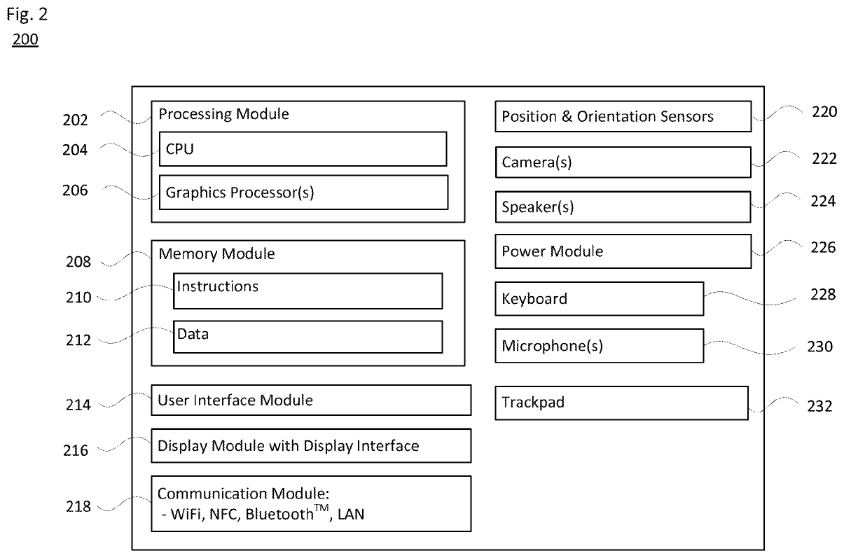

FIG. 2 illustrates a block diagram of an example client computing device 200, such as the laptop shown in FIG. 1 (e.g., a tablet PC or netbook), a desktop PC, an in-home device such as a smart display, or the like. As shown, the client computing device 200 includes a processing module 202 having one or more computer processors such as a central processing unit 204 and/or graphics processors 206, as well as memory module 208 configured to store instructions 210 and data 212. The processors may or may not operate in parallel, and may include ASICs, controllers, and other types of hardware circuitry. The processors are configured to receive information from a user through user interface module 214, and to present information to the user on one or more display devices of the display module 216 having a display interface.

User interface module 214 may receive commands or other input information from a user via user inputs and convert them for submission to a given processor. The user interface module may link to a web browser and other applications executed by the computing device's processing module 202. The user inputs may include one or more of a touchscreen, keypad, trackpad, stylus, microphone, or other types of input devices. The display module 216 may comprise appropriate circuitry for driving the display device to present graphical and other information to the user. By way of example, the graphical information may be generated by the graphics processor(s) 206, while CPU 204 manages overall operation of the client device 200. The graphical information may display responses to user queries or other content on the display module 216. For instance, the processing module may run a browser application, messaging application or other service using instructions and data stored in memory module 208, and present information associated with the browser application or other service to the user via the display module 216. The memory module may include a database or other storage for application-related information, etc.

Memory module 208 can be implemented as one or more of a computer-readable medium or media, a volatile memory unit or units, or a non-volatile memory unit or units. The memory module 208 may include, for example, flash memory and/or NVRAM, and may be embodied as a hard-drive or memory card. Alternatively or additionally, the memory module 208 may also include removable media (e.g., DVD, CD-ROM or USB thumb drive). One or more regions of the memory module 208 may be write-capable while other regions may comprise read-only (or otherwise write-protected) memories. In one implementation, a computer program product is tangibly embodied in an information carrier. Although FIG. 2 functionally illustrates the processor(s), memory module, and other elements of client computing device 200 as being within the same overall block, such components may or may not be stored within the same physical housing. For example, some or all of the instructions and data may be stored on an information carrier that is a removable storage medium (e.g., optical drive, high-density tape drive or USB drive) and others stored within a read-only computer chip.

The data 212 may be retrieved, stored, or modified by the processors in accordance with the instructions 210. For instance, the data may be stored in computing device registers, in a relational database as a table having a plurality of different fields and records, XML documents or flat files. The data may also be formatted in any computing device-readable format.

The instructions 210 may be any set of instructions to be executed directly (such as machine code) or indirectly (such as scripts) by the processor(s). For example, the instructions may be stored as computing device code on the computing device-readable medium. In that regard, the terms “instructions” and “programs” may be used interchangeably herein. The instructions may be stored in object code format for direct processing by the processor(s), or in any other computing device language including scripts or collections of independent source code modules that are interpreted on demand or compiled in advance.

As also shown in FIG. 2, the client device 200 includes a communication module 218 for communicating with other devices and systems, including other client devices, servers and databases. The communication module 218 includes a wireless transceiver; alternatively, the module may alternatively or additionally include a wired transceiver. The client device 200 may communicate with other remote devices via the communication module 218 using various configurations and protocols, including short range communication protocols such as near-field communication (NFC), Bluetooth™, Bluetooth™ Low Energy (BLE) or other ad-hoc networks, the Internet, intranets, virtual private networks, wide area networks, local networks, private networks using communication protocols proprietary to one or more companies, Ethernet, WiFi and HTTP, and combinations of the foregoing.

The example client device 200 as shown also includes one or more position and orientation sensors 220. The position and orientation sensors 220 are configured to determine the position and orientation of one or more parts of the client computing device 200. For example, these components may include a GPS receiver or other global positioning component to determine the device's latitude, longitude and/or altitude as well as an accelerometer, gyroscope or another direction/speed detection device such as an inertial measurement unit (IMU). The client device 200 may also include one or more camera(s) 222 for capturing still images and recording video streams such as the integrated webcam as discussed above, speaker(s) 224. Power module 226 provides power to the various system components. In addition, user inputs include a keyboard 228 and a microphone 230, which may comprise a microphone array having one or more transducers or other microphone elements distributed at various points along the housing of the computing device. Trackpad 232 may include either a capacitive touch sensor unit 234a or a piezoelectric sensor unit 234b (or both).

### Example Mobile Device

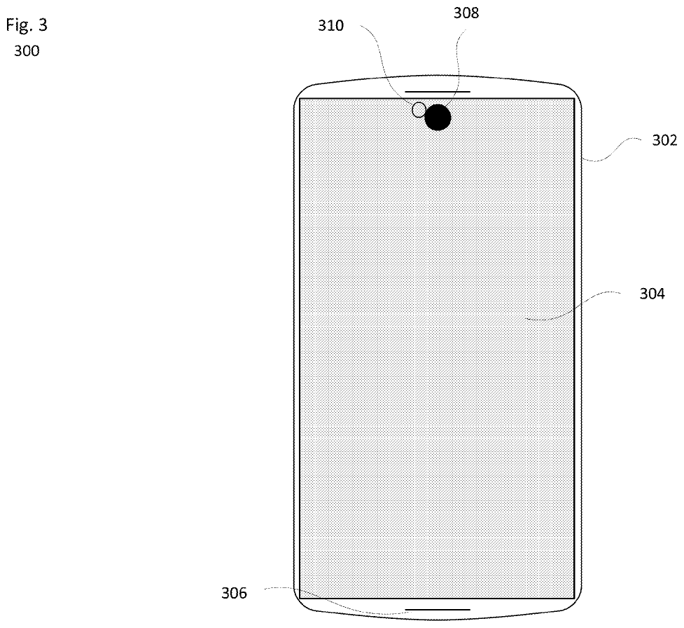

FIG. 3 illustrates an example 300 showing a handheld-type client mobile device 302, such as a smartphone, personal digital assistant (PDA) or wearable (e.g., a smartwatch). In this example, there is a display 304 for visually presenting content. The display 304 may also be configured as a user input (e.g., a touchscreen). A microphone 306 may be provided for audible input. An integrated camera 308 can be used for capturing photos, videoconferences, interactive gaming, etc. Indicator 310, such as an LED, may be illuminated to alert a user whenever the integrated camera 308 is in use.

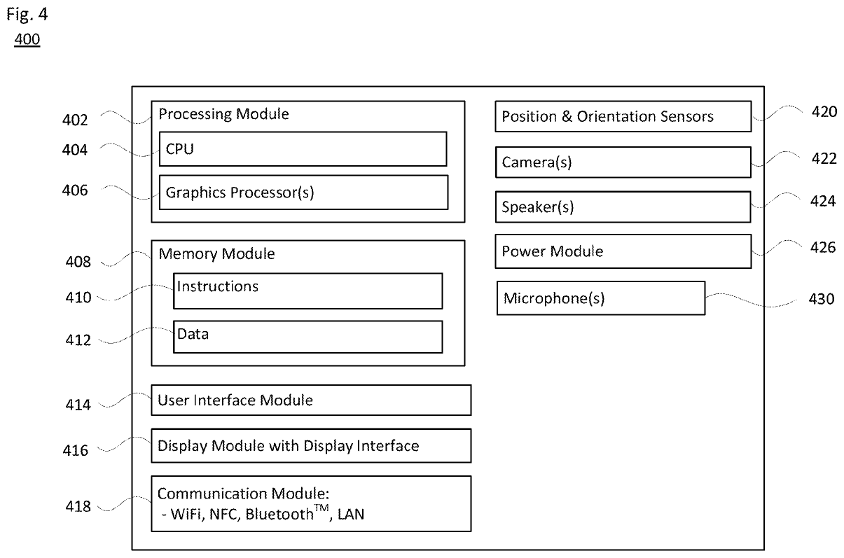

FIG. 4 illustrates a block diagram of an example handheld client mobile device 400, such as the smartphone shown in FIG. 3. As shown, the client mobile device 400 includes a processing module 402 having one or more processors such as a central processing unit 404 and/or graphics processors 406, as well as memory module 408 configured to store instructions 410 and data 412. The processors may or may not operate in parallel, and may include ASICs, controllers, and other types of hardware circuitry. The processors are configured to receive information from a user through user interface module 414, and to present information to the user on one or more display devices of the display module 416 having a display interface.

User interface module 414 may receive commands or other input information from a user via user inputs and convert them for submission to a given processor. The user interface module may link to a web browser and other applications executed by the mobile device's processing module 402. The user inputs may include one or more of a touchscreen, stylus, microphone, or other types of input devices. The display module 416 may comprise appropriate circuitry for driving the display device to present graphical and other information to the user. By way of example, the graphical information may be generated by the graphics processor(s) 406, while CPU 404 manages overall operation of the client mobile device 400. The graphical information may display responses to user queries on the display module 416. For instance, the processing module may run an application or other service using instructions and data stored in memory module 408, and present information associated with the application or other service to the user via the display module 416. The memory module may include a database or other storage for application-related information, etc.

Memory module 408 can be implemented as one or more of a computer-readable medium or media, a volatile memory unit or units, or a non-volatile memory unit or units. The memory module 208 may include, for example, flash memory and/or NVRAM, and may be embodied as a hard-drive or memory card. One or more regions of the memory module 408 may be write-capable while other regions may comprise read-only (or otherwise write-protected) memories.

The data 412 may be retrieved, stored, or modified by the processors in accordance with the instructions 410. For instance, the data may be stored in computing device registers, in a relational database as a table having a plurality of different fields and records, XML documents or flat files. The data may also be formatted in any computing device-readable format.

The instructions 410 may be any set of instructions to be executed directly (such as machine code) or indirectly (such as scripts) by the processor(s). For example, the instructions may be stored as mobile device code on the mobile device-readable medium. In that regard, the terms “instructions” and “programs” may be used interchangeably herein. The instructions may be stored in object code format for direct processing by the processor(s), or in any other computing device language including scripts or collections of independent source code modules that are interpreted on demand or compiled in advance.

As also shown in FIG. 4, the client mobile device 400 includes a communication module 418 for communicating with other devices and systems, including other client devices, servers, and databases. The communication module 418 includes a wireless transceiver. The client device 400 may communicate with other remote devices via the communication module 418 using various configurations and protocols, including short range communication protocols such as near-field communication (NFC), Bluetooth™, Bluetooth™ Low Energy (BLE) or other ad-hoc networks, the Internet, intranets, virtual private networks, wide area networks, local networks, private networks using communication protocols proprietary to one or more companies, WiFi and HTTP, and combinations of the foregoing.

The example client device 400 as shown also includes one or more position and orientation sensors 420. The position and orientation sensors 420 are configured to determine the position and orientation of one or more parts of the client mobile device 400. For example, these components may include a GPS receiver or other global positioning component to determine the device's latitude, longitude and/or altitude as well as an accelerometer, gyroscope or another direction/speed detection device such as an inertial measurement unit (IMU). The mobile device 400 may also include one or more camera(s) 422 for capturing still images and recording video streams such as the integrated camera as discussed above, speaker(s) 424. Power module 426 provides power to the various system components. In addition, user inputs may include a microphone 430, which may comprise a microphone array having one or more transducers or other microphone elements distributed at various points along the housing of the computing device.

### Example Network

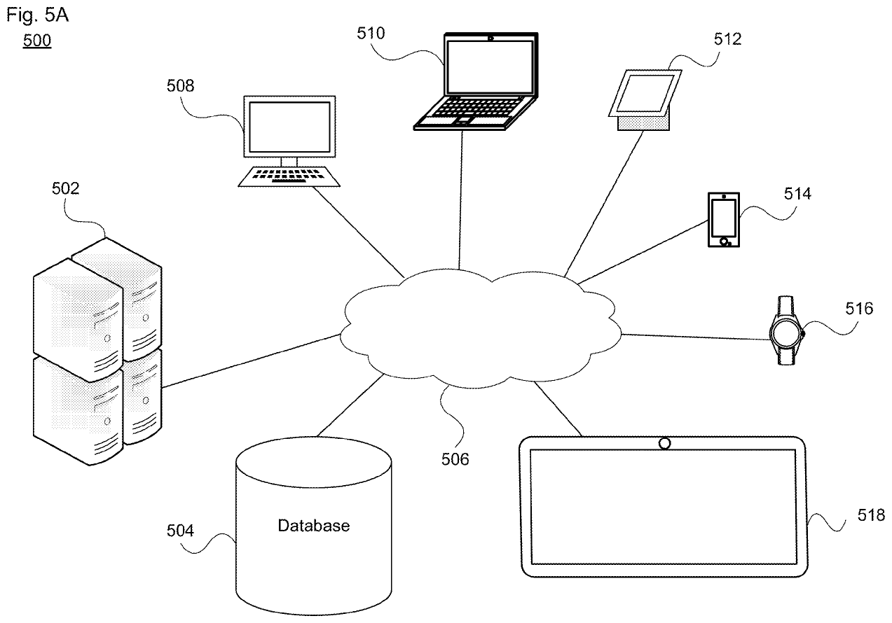

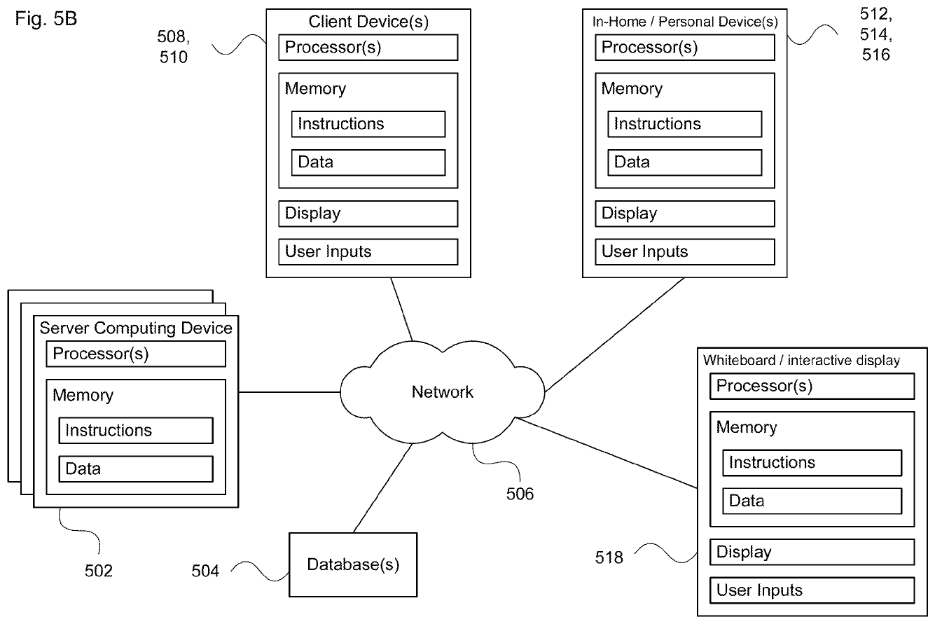

One or more devices may connect to one another over a network in order to stream applications or apps as discussed further herein. FIGS. 5A and 5B are pictorial and functional diagrams, respectively, of an example system 500 that includes a plurality of computing devices and databases connected via a network. For instance, computing device(s) 502 may be a cloud-based server system that provides or otherwise supports one or more apps, games, or other programs. Database 504 may store messaging app information, game data, user profile information, and/or other information. The server system may access the databases via network 506. Client devices may include one or more of a desktop computer 508, a laptop or tablet PC 510 and in-home devices such as smart display 512. Other client devices may include a personal communication device such as a mobile phone or PDA 514 or a wearable device 516 such as a smartwatch, etc. Another example client device is a large screen display or interactive whiteboard 518, such as might be used in a classroom, conference room, auditorium or other collaborative gathering space where multiple users may be present. An additional client device may be a pair of headphones or earbuds (not shown).

In one example, computing device 502 may include one or more server computing devices having a plurality of computing devices, e.g., a load balanced server farm or cloud computing system, that exchange information with different nodes of a network for the purpose of receiving, processing, and transmitting the data to and from other computing devices. For instance, computing device 502 may include one or more server computing devices that are capable of communicating with any of the computing devices 508-518 via the network 506. This may be done as part of hosting one or more collaborative apps (e.g., a video conferencing program, an interactive spreadsheet app or a multiplayer game) or services (e.g., a movie streaming service or interactive game show where viewers can provide comments or other feedback).

As shown in FIG. 5B, each of the computing devices 502 and 508-518 may include one or more processors, memory, data and instructions. The memory stores information accessible by the one or more processors, including instructions and data that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing; whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs. Alternatively, each processor may be a dedicated device such as an ASIC, graphics processing unit (GPU), tensor processing unit (TPU) or other hardware-based processor. Although FIG. 4B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 1402. Accordingly, references to a processor or computing device will be understood to include references to a collection of processors or computing devices or memories that may or may not operate in parallel.

The computing devices may include all of the components normally used in connection with a computing device such as the processor and memory described above as well as a user interface subsystem for receiving input from a user and presenting information to the user (e.g., text, imagery and/or other graphical elements). The user interface subsystem may include one or more user inputs (e.g., at least one front (user) facing camera, a mouse, keyboard, touchscreen and/or microphone) and one or more display devices that operable to display information (e.g., text, imagery and/or other graphical elements). Other output devices, such as speaker(s) may also provide information to users.

The user-related computing devices (e.g., 508-518) may communicate with a back-end computing system (e.g., server 502) via one or more networks, such as network 506. The network 506, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

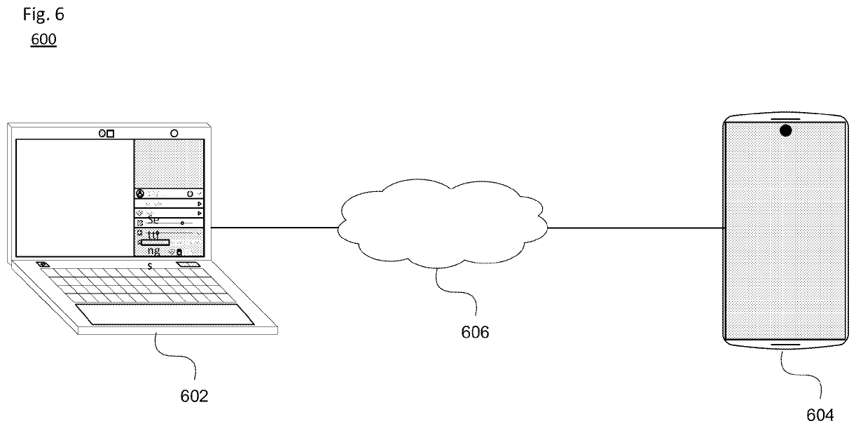

In some implementations, the user-related computing devices may also communicate with one another without also communicating with a back-end computing system. For example, FIG. 6 illustrates a system 600 where a client computing device 602 (e.g., a laptop) and client mobile device 604 (e.g., a mobile phone) are wirelessly connected via a network 606. The client computing device 602 may be the client computing device discussed with regard to FIGS. 1-2. Similarly, the client mobile device 604 may be the client mobile device discussed with regard to FIGS. 3-4. The network 606, and intervening nodes, may include the same configuration as network 506. Alternatively or additionally, the network 606 may comprise one or more ad hoc and/or peer to peer communication links between the devices 602 and 604. Here, there would be no intervening nodes.

### Example Methods

### Pairing

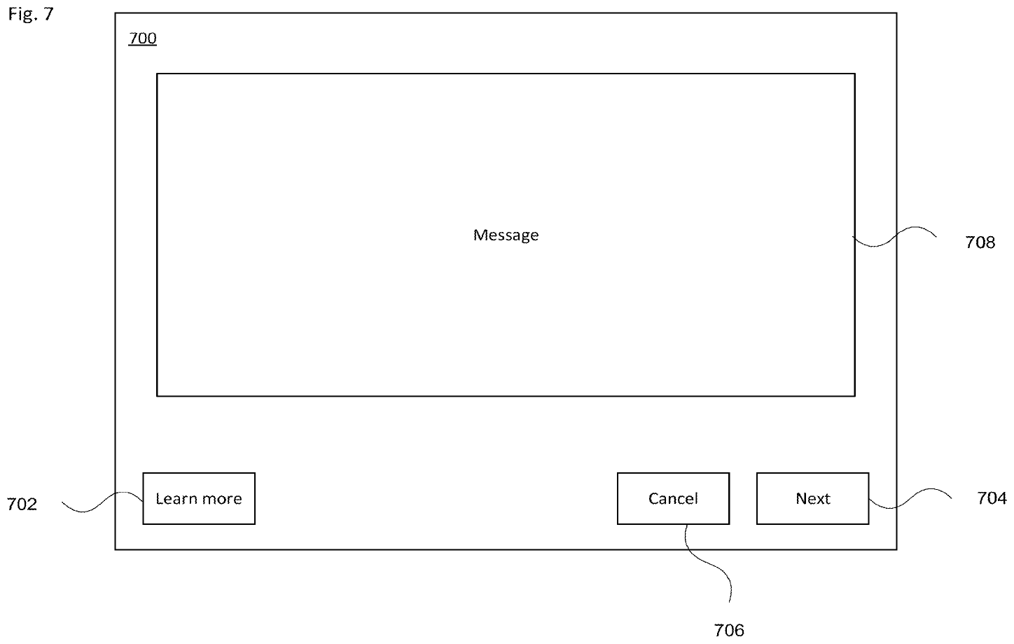

While initiating an application streaming process in accordance with aspects of the technology, a client mobile device and a client computing device may connect to each other using a first wireless connection such as, for example, a Bluetooth™ connection or other ad hoc connection. When initiating a connection, one of the user's computing devices (either the mobile device or the computing device) may generate prompts to cause the user to pair the devices (a process that allows two or more devices to communicate directly when in range of one another) as shown in FIGS. 7-11. In FIG. 7, a first prompt 700 in the GUI (here, on the user computing device) may provide a message 708 to inform a user regarding the functionality of the pairing. The first prompt 700 may include a link contained in the text “Learn more” 702, allowing a user to access additional information such as a user agreement, pairing details, supported applications, etc. The first prompt 700 may additionally include a link to terminate the process contained in the text “Cancel” 706, and a link to proceed to the next prompt contained in the text “Next” 704.

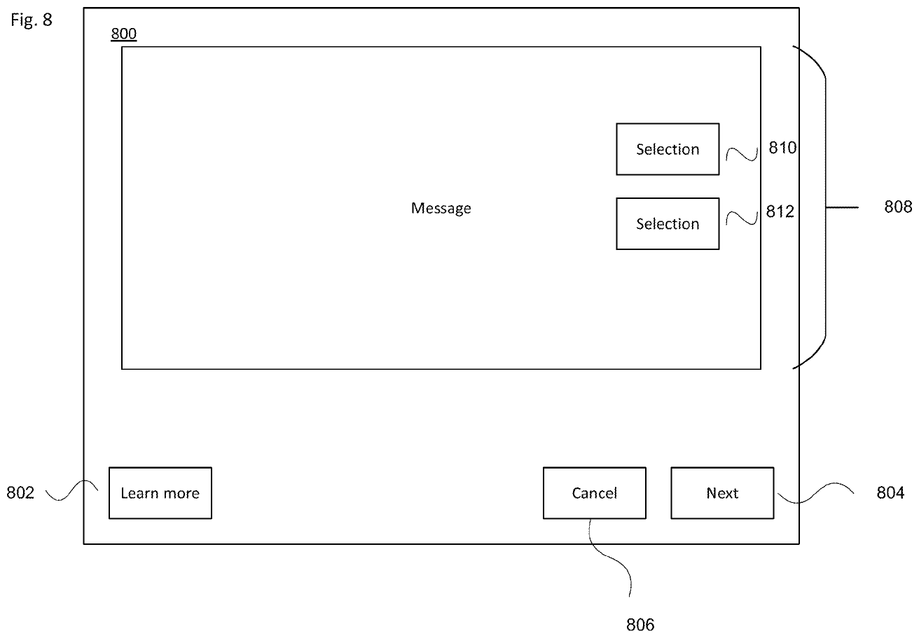

After the user selects “Next” 704 using one or more user interfaces of the computing device (e.g., touchscreen, trackpad, mouse, keyboard, microphone, or gesture, etc.), the device may generate a second prompt 800 in the GUI as illustrated in FIG. 8. The second prompt 800 may provide a message 808 and contain one or more selections 810,812 to enable the user to establish privacy safeguards. The user may elect to enable password protection, pin protection, or both which may need to be entered by the user when the mobile device, the computing device, or both go to sleep (e.g., components such as the screen power down). The second prompt 800 may similarly contain “Learn more” 802, “Cancel” 806, and “Next” 804 links that the user may engage with. In some implementations, the second prompt 800 may not be generated, for example, if the user had previously established a password, pin, or both.

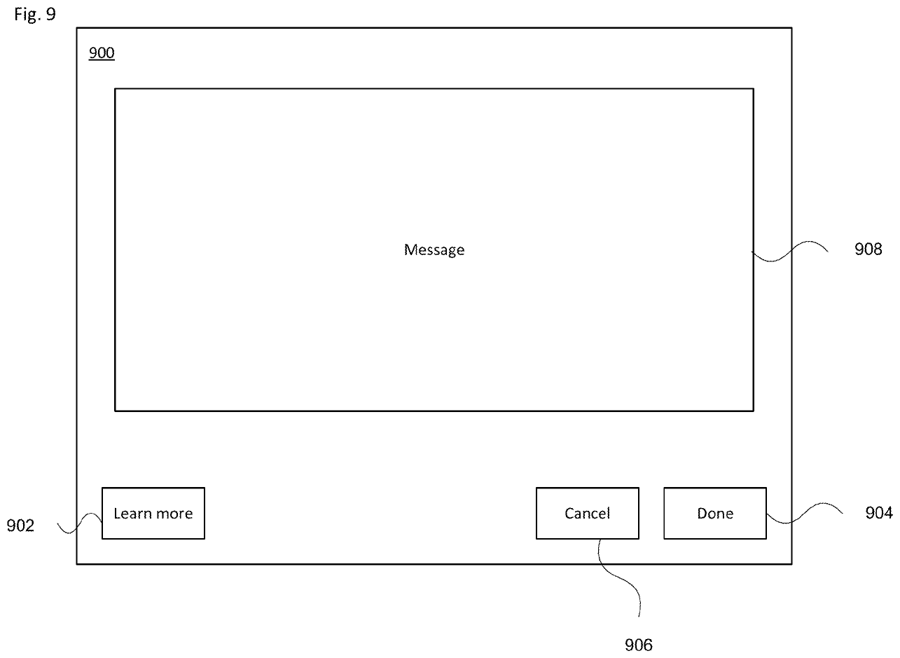

After the user makes a selection 810,812, the user may select “Next” 804. The computing device may then generate a third prompt 900 in the GUI as shown in FIG. 9. The third prompt may similarly contain “Learn more” 902 and “Cancel” 906 links. The third prompt 900 enables the user to continue the pairing process on the mobile device with a message 908 that, for example, may state “Go to your phone to review a few more permissions.” The third prompt 900 also contains a link to exit the pairing processes upon completion contained in the text “Done” 904. The link “Done” 904 may not be active until the user completes the permissions process.

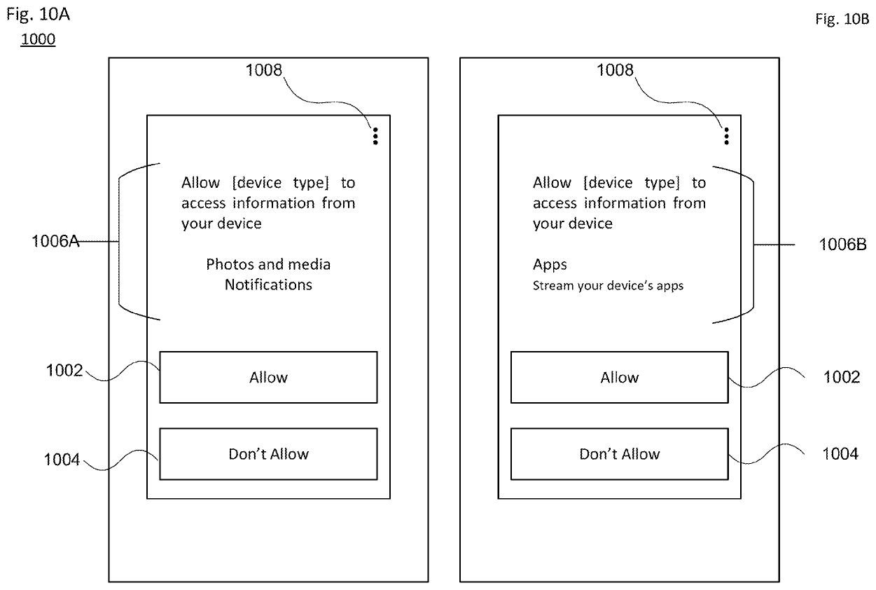

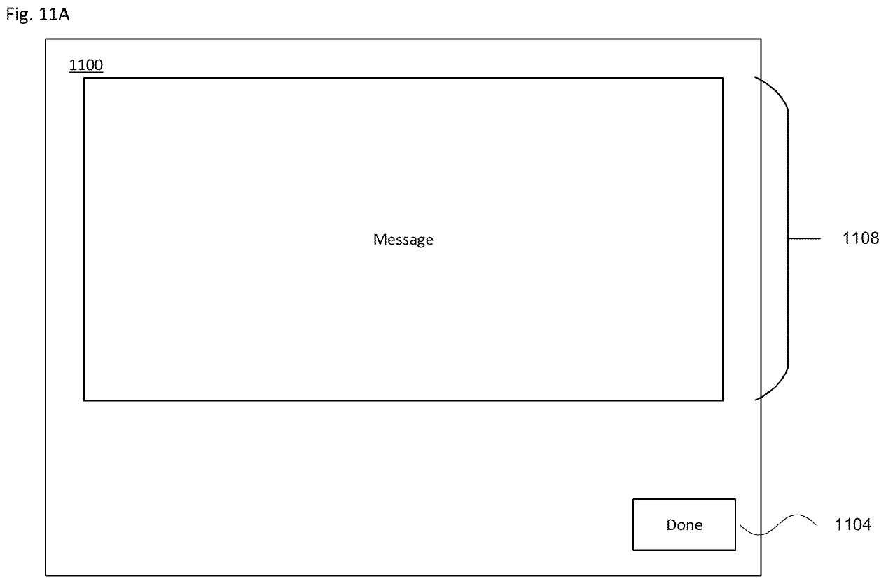

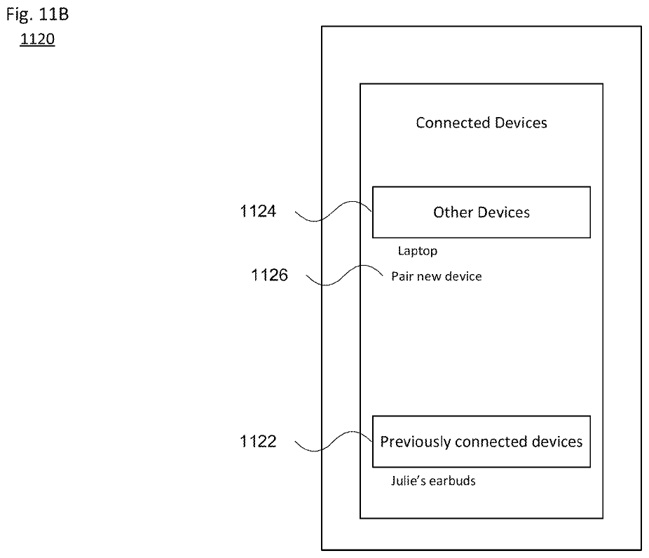

In this scenario, after the third prompt 900 is generated on the user computing device, at least one permission prompt 1000 may be generated on the user mobile device as shown in FIGS. 10A-B. The user may either allow or deny the permissions (e.g., access to photos and media, notifications, and applications) via the “Allow” 1002 or “Don't allow” 1004 links. A message 1006 may inform the user what permissions are requested. Here, as shown by 1006A in FIG. 10A, the message section may indicate the device type to be allowed access, along with other information such as notifications and/or photos and media. As shown by 1006B in FIG. 10B, the message section may indicate the device type as above, but also present different information such as an Apps notice regarding streaming the device's apps. Additional information about the streaming implementation may be found by clicking on icon 1008. If a user selects “Don't allow” 1004 the pairing process is terminated. If the user selects “Allow” 1002, a fourth prompt 1100 may be generated in the GUI on the computing device as illustrated in FIG. 11A. The fourth prompt 1100 presents a message 1108 informing the user the mobile device and the computing device are paired and contains a link to exit the pairing processes upon completion contained in the text “Done” 1104. In some implementations, the permission prompt may not be generated on the mobile device if the user has previously accepted the permissions for the computing device to access the mobile device. When there is an active connection, the mobile device GUI may show a “Connected Devices” screen 1120 as illustrated in FIG. 11B. This screen can show previously connected devices at 1122, other devices at 1124, and the option to pair a new device at 1126.

After the user selects “done” or otherwise completes the process, the mobile device and computing device may remain paired and may share content when in direct communication range of one another. This range may be within 2-5 meters or more, depending on the type of connection (e.g., a Bluetooth™ or Bluetooth LET link). According to one aspect, the connection is maintained to retain the device pairing. The computing device, client device, or both, may periodically test for the network connection. If the connection is not detected then the computing device, client device, or both may display a “timed out” message. A connection may not be detected due to, for example, the devices being out of range of one another, interference on a communication channel, etc. If the connection is reestablished the message may disappear. Otherwise, the connection may terminate, and in one scenario automatically reconnect when the computing device and mobile device are once again within range of one another. If the devices are out of range or are otherwise unable to connect, a notification may be generated to communicate this to the user.

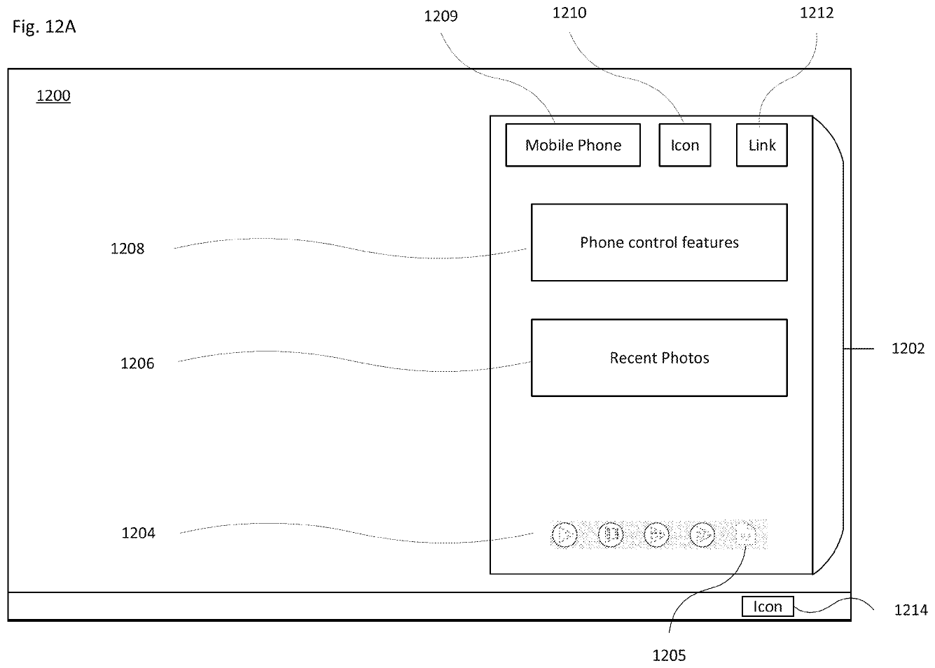

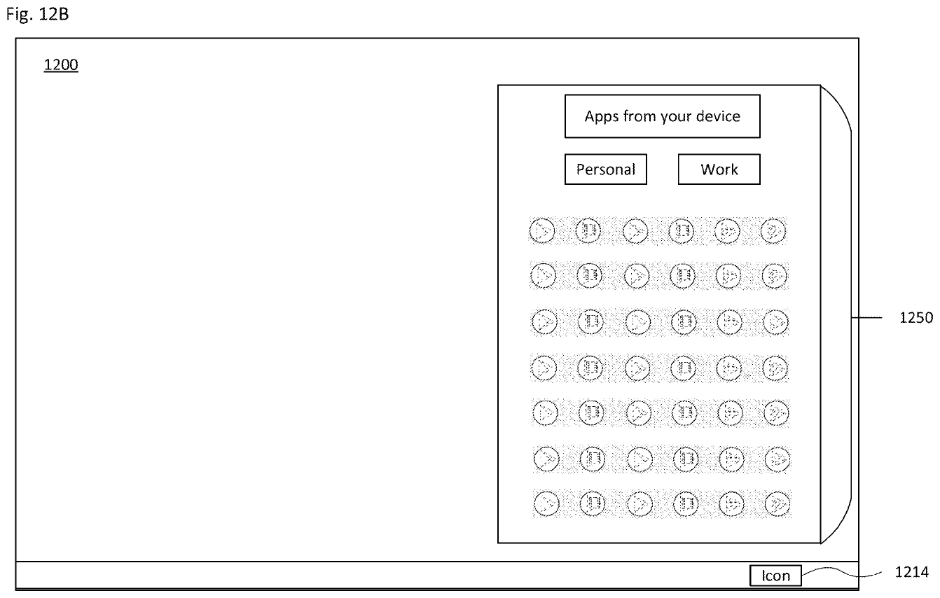

The pairing of the computing device and the mobile device allows a user to access features of the mobile device by app streaming via a GUI on the computing device. As illustrated in FIG. 12A, a mobile device interface 1202 is located in the GUI on the display 1200 of the computing device. The interface 1202 may include features such as an apps selection 1204, a recent photos selection 1206, phone control features 1208 (e.g., hotspot control, phone volume control, locate phone, etc.), mobile device name 1209, mobile device status icons 1210 (e.g., power level, mobile network connection), and a mobile device settings menu link 1212. The apps selection 1204 may include a link and corresponding icon 1205 which may direct a user to an apps list. In some instances, the apps selection 1204 may be a recent apps selection. Alternatively, the apps selection 1204 may be a favorite apps selection. In this regard, a user may select, via settings menu, the apps selection 1204 to be one of a recent apps selection or a favorite apps selection. In some implementations, the computing device may also display an icon 1214 contained in the taskbar of the computing device, indicating the mobile device is paired and currently connected to the computing device. The icon May 1214 also indicate when the devices are paired but not currently connected. Both the computing device and the mobile device may additionally contain a list of paired devices within a settings menu. Once paired, the computing device may show the mobile device as paired and vice versa. Additionally, the respective lists may indicate if the device is currently connected to the other.

In some implementations, the link and corresponding icon 1205, may direct a user to the apps list. An example apps list 1250 is illustrated in FIG. 12B. While FIG. 12B illustrates an apps list 1250 in the form of a grid, the apps list may also be in the form a lined list (e.g., one icon or app per line). In some instances, the apps list 1250 may allow a user to view personal apps and work apps separately. In this regard, a user may select or pin apps as work apps. When work apps are viewed the selected or pinned work apps may be displayed on the apps list. When personal apps are viewed, the apps not selected or pinned as work apps may be displayed on the apps list. Additionally or alternatively, the apps list may contain a favorites list. The favorites list may include apps selected or pinned by a user as a favorite.

### Application Streaming

Following the pairing of the computing device and mobile device via the first wireless connection, a user may begin application streaming so long as the pairing connection is maintained. Here, the system (the mobile device, the computing device, or both) may check periodically to ensure that the pairing connection is maintained (e.g., every 10-30 seconds, or more or less). According to one aspect, streaming of the app may employ a second wireless connection, such as a Web Real-Time Communication (WebRTC) connection. This connection may employ a different wireless connection, such as a WiFi connection. In one implementation, the first wireless connection may be utilized to ensure proximity between the computing device and the mobile device while the second wireless connection may be utilized to communicate stream information between the devices. The system may inform the user that the pairing connection has been lost (e.g., the mobile device and the computing device arc out of Bluetooth™ range), and a timeout can be set where the streaming connection may be severed if not re-established before the timeout is reached. Here, the system may auto reestablish the pairing connection when the devices are back in range of one another.

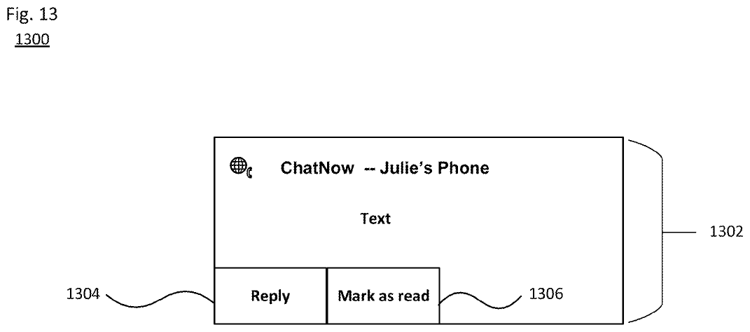

Application streaming on a user computing device may be initiated in several ways, and may be managed by the device's operating system running one or more modules via the device's processors. In one example, an application notification 1302 may be generated on the GUI of the computing device display 1300 as shown in FIG. 13. In this example, the notification 1302 is a mirrored notification, meaning that the notification may be displayed on both the computing device and the mobile device. The mirrored notification may appear identical in both displays, or have a different appearance (e.g., due to screen size and/or orientation). The user may interact with the notification 1302 using the user interface. For example, besides ignoring the notification, the user may dismiss (and that dismissal may also apply to the connected phone or other device running the app), reply in-line (i.e., never leave the notification), or tap the notification to stream the full app from the other device. For example, the app may be a messaging app. The notification for a messaging application illustrated in FIG. 13 includes the option to select “REPLY” 1304, “MARK AS READ” 1306, or select the body of the notification. In this example, if the user selects “MARK AS READ” 1306, the message may be marked as read, meaning the message notification may no longer appear on the mobile device or the computing device.

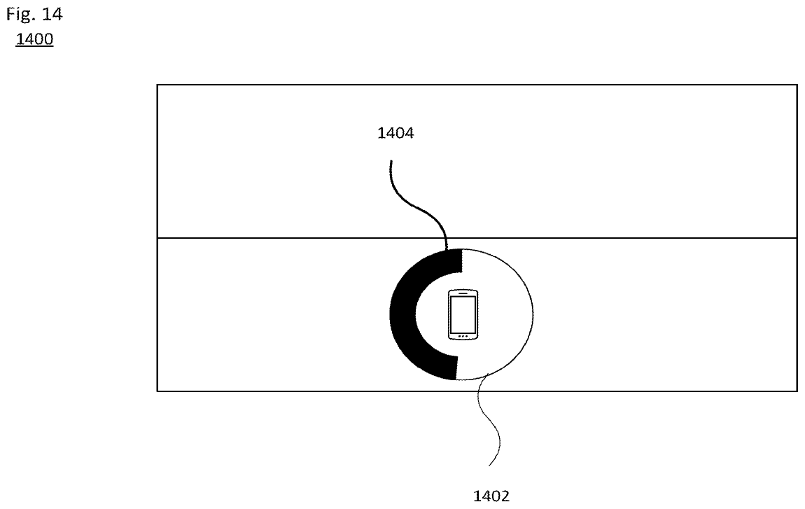

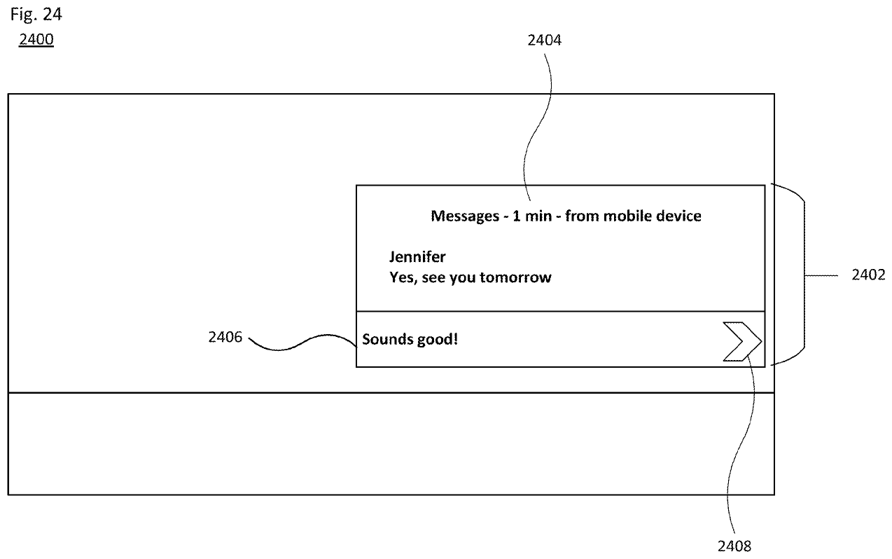

If the user selects “REPLY” 1304 or selects the body of the notification, the messaging application may be streamed on the computing device. As shown in example 1400 of FIG. 14, an icon 1402 with a circular progress bar 1404 is displayed on the computing device, indicating the loading status of the application stream. The icon 1402 may be located on any portion of the computing device display. In an implementation that includes a reply in-line feature, discussed below with respect to FIG. 24, if the User selects “REPLY” 1304, the user may reply within the mirrored notification without streaming the app. In such an implementation, the stream may be initiated from the notification by selecting the body of the notification. In one example, the notification may be actionable by the user such that upon receiving input from the user, a signal may be transmitted to the device running the app, in which the signal may be configured to cause that device to perform an action associated with the application.

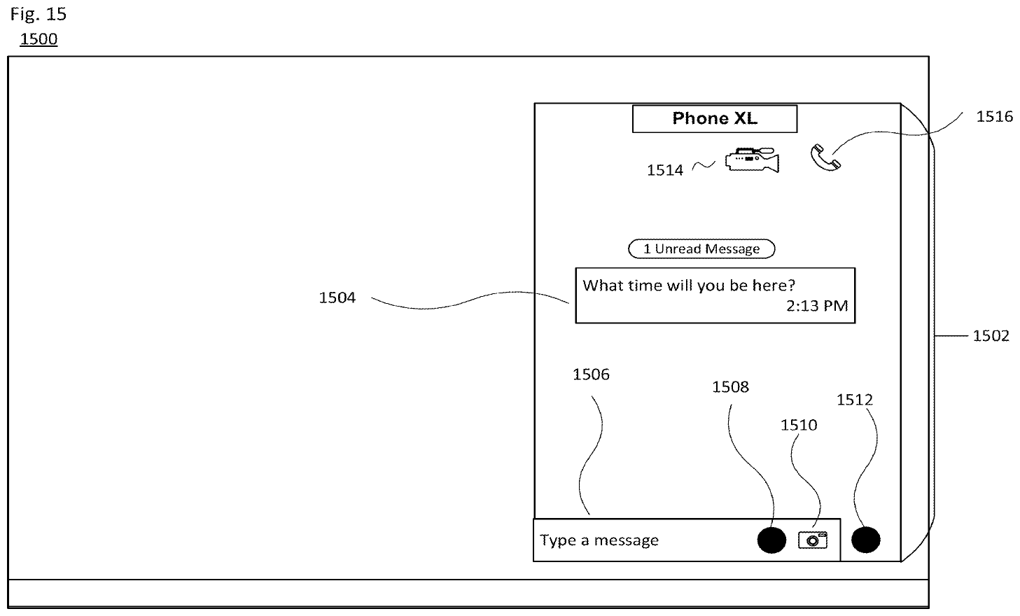

After the application stream is loaded, a user may interact with the stream through the user interface as illustrated in view 1500 of FIG. 15. While Fig, 15 illustrated the stream in a portrait view, the stream may additionally be in a landscape view or a full screen view. Additionally or alternative, the stream may be able to alternate between portrait, landscape, and full screen views. The stream 1502 on the computing device allows the same application functionality as on the mobile device. For example, if the application is a messaging application as illustrated in FIG. 15, the stream 1502 may include the ability to enter text in a text box 1506, attach files or photographs via icon 1508 from either the computing device or the mobile device, capture new photographs via icon 1510, input voice commands via input 1512, start a video call via icon 1514, and/or start a call via icon 1516. Such features may be accessible through the user interface(s) of the computing device.

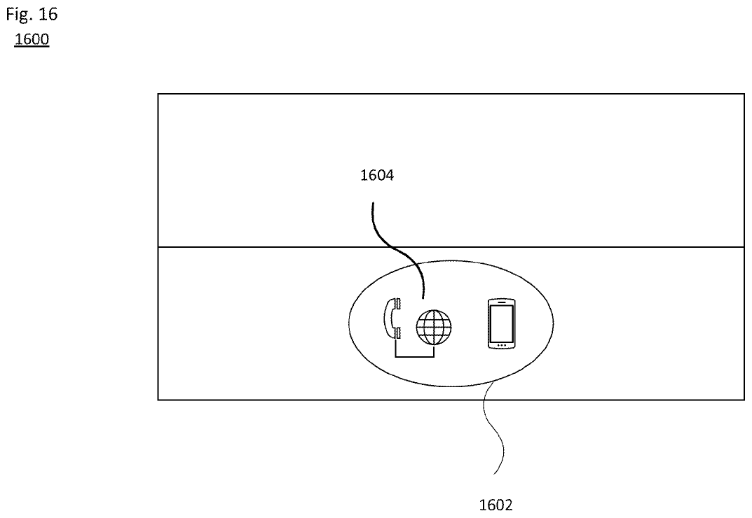

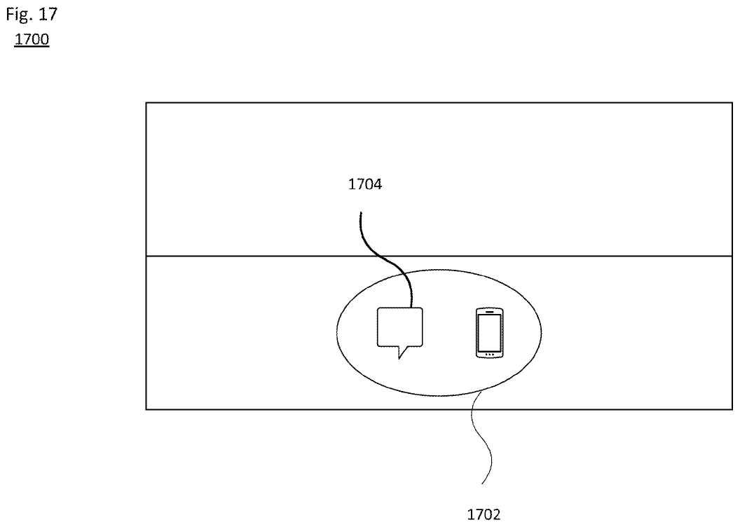

In some scenarios, after the stream is loaded, the corresponding icon may additionally display the application symbol to indicate what application is currently streaming. For example, as shown in view 1600 of FIG. 16, the icon 1602 includes the logo 1604 to indicate the particular app that is streaming on the computing device. Similarly, view 1700 of FIG. 17 illustrates a scenario where a messenger application is streaming, and the icon 1702 includes the messenger application logo 1704. Alternatively, the user may choose not to interact with the notification. When the user does not interact with the notification, the notification may recede after a period of time (e.g., 20 seconds, or more, or less). Any notifications may be accessible to the user in a notification center discussed in further detail below.

In another example, a user may manually select an application for streaming. The user may manually select an application by, for example, selecting an app from a list of mobile device applications on the computing device or by selecting an app to stream to the computing device from the mobile device.

In a further example, the system may implement smart audio source selection, where the system automatically determines whether to play audio from the mobile device directly or from the computing device. This can include providing seamless headphone (or earbud) switching between the audio sources. Here, the selection may be based on whether the headphones (or earbuds) are currently paired with either (or both) of the mobile device or the computing device. If there is pairing with both devices, the system may have the headphones (or earbuds) connect to a particular device based on physical proximity (which can be estimated, e.g., by evaluating signal strength information from the pairing), the type(s) of apps being streamed, etc.

In another example, a user may select an application from an apps selection or apps list for streaming. In one instance, the apps selection may be a favorite apps selection. For an application to be a favorite app, a user may designate an app as such. In one example, the app may have been pinned or selected as a favorite app on an apps list (e.g., apps list 1250). A recent application may be selected via the user interface for streaming, e.g., from apps selection 1204 list illustrated in FIG. 12A. After selection, the application may begin streaming on the computing device. In instance, a user may select a recently used application for streaming. For an application to be considered recently used, in one example, the app may have been streamed on the computing device or utilized on the mobile device within a certain timeframe (e.g., 30 minutes, 4 hours, within the last day, or some other timeframe). The timeframe could be set by the user or be a default timeframe. A recent application may be selected via the user interface for streaming, e.g., from apps selection 1204 list illustrated in FIG. 12A.

After selection, the application may begin streaming on the computing device. More than one app may stream between the devices at a time. The stream may resume streaming content from when the user most recently accessed the application. For example, if a user streamed an application on the computing device, ended the stream, and then selected the application from apps selection 1204, the computing device may stream the application as it was when the user ended the stream. In another example, if a user streamed an application on the computing device, ended the stream, and started using the application on the mobile device, the application may resume as it was when the user ended the stream. In this regard, the stream may be paused when inactive, such as when a user ends a stream. However, the app may persist on the source device (e.g., the mobile device) as a background operation. Such persistence as a background operation may allow the app to be resumed by the user.

Similarly, if the user then closed the application on the mobile device and selected the application from the apps selection 1204 or apps list 1250, the computing device could stream the application as it was when the user closed the application on the mobile device. In one example, the system (e.g., on the mobile device) may cache a full color image of the streamed app when the stream is closed to preserve the current stream state. The cached image may be used as a starting image to present when again streaming the app, e.g., when the user elects to do so by interacting with the link or initiating the stream in any manner as discussed above. The cached image may be stored as long as the connection between the computing device and the mobile device is maintained.

When streaming an application on the computing device, the application need not be displayed on the mobile device. According to one scenario, to generate a stream, the mobile device creates a virtualized remote display for presentation on the computing device. The mobile device encodes virtualized remote display, including the application content to be streamed (e.g., audio, video, etc.). The mobile device may, for example, use an H.264 or MPEG-4 AVC encoder to ensure the quality of the streamed content. The encoded information, including the application content, may be sent to the computing device over the connection between the devices. Upon receipt, the computing device decodes and renders the virtualized remote display, thereby allowing the computing device to stream the application. The computing device may function as an input device for the virtualized remote display. User inputs may be received from the computing device, which are then communicated through the wireless connection to the mobile device. The mobile device may then update the virtualized remote display based on the user inputs. Thus, the mobile device both acts on the received user inputs and modifies the virtualized remote display. In this regard, a streamed application may be hosted by the mobile device, meaning the processing module and the memory module of the mobile device are utilized to run the application. The computing device renders the virtualized remote display and acts as an input device but does not require a streamed application to be installed on the computing device. The virtualized remote display may be formatted as a web page, which enables the computing device to set its display size as desired. Thus, the virtualized remote display appearance (e.g., portrait or landscape mode or total size) may be modified during streaming. Additionally, no application information (e.g., data, instructions) needs to be stored in the computing device. In some instances, the mobile device may display an indication or notification to a user that an app stream is occurring. In this regard, the virtualized remote display provides a stylized view of an app on the GUI of the computing device that more readily enables a user to control the app using inputs from the computing device. The inputs are conveyed to the mobile device on which the virtualized remote display is generated.

According to one aspect, user interactions with the streamed app on the computing device are ephemeral, meaning that information about the streaming may not be stored by the computing device once it passes signals to the mobile device (e.g., user control of an audio or video stream). By way of example, the input events (e.g., pause a song, reply to a text) are translated at the computing device into a format that can be processed by the mobile device. This can include processing touch, mousepad, cursor, audio, or gesture inputs into signals that can be acted on by the app running on the mobile device. For instance, in a messaging app, a primary action can be to press the enter key to send a message; however, the app running on the mobile device may not support that feature. In such an instance, the mobile device may run a machine learning (ML) model that determines what input(s) maps to sending, so that the mobile device may map the input(s) when such input(s) are received from the computing device.

As opposed to screen mirroring, app streaming does not require the mobile device to show the same content as what is being streamed on the computing device. The user is free to keep their mobile device screen powered off or dimmed, or interact with another app mid-stream. Thus, while the virtualized remote display is streamed on the computing device, the mobile device may perform other functions. For example, the mobile device may enter a sleep mode (e.g., where the display of the mobile device may be off or present a screen saver) and may still generate the virtualized remote display on the computing device. In this regard, a portion processing module, such as an application processor, of the mobile device may remain active to generate the stream while the display of the mobile device is inactive. Alternatively, the mobile device may allow a user to interact with an additional application while generating the stream to the computing device. In one scenario, the user can minimize the streamed app, where it may remain minimized for a selected amount of time (e.g., 5 minutes, or more or less), after which it can automatically close to preserve the mobile device's battery. In this regard, the virtualized remote display may be considered, in essence, a secondary display using a secondary set of inputs and outputs (e.g., the inputs and outputs of the computing device), such that the mobile device inputs and outputs (e.g., display, microphone, speakers, etc.) may be powered down or utilized for a different function.

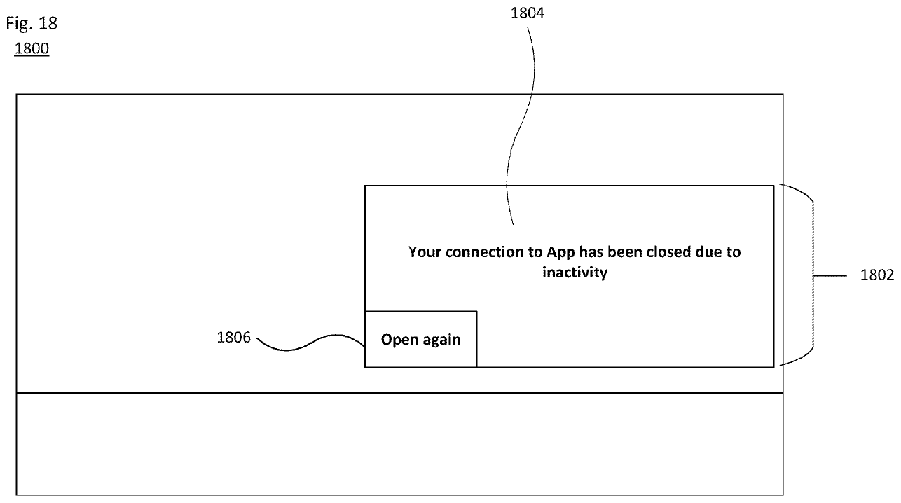

A user may stop an app stream in several ways. In one example, a stream may be closed due to user inactivity (e.g., no user interaction with the streamed application for some minimum amount of time). By way of example, for a stream to be closed due to inactivity, the stream may be idle for a period of time such as 10-15 minutes or more or less. When a stream is stopped due to inactivity, as shown in view 1800 of FIG. 18, a message 1802 may be generated for display on the computing device. The message 1802 may include text 1804 informing the user the connection or stream was terminated due to inactivity. The message may also include a link contained in the text “Open again” 1806 for the user to reopen the steam. As noted above, the system may cache an image (e.g., a full color image) of the streamed app when the user is idle for the period of time to preserve the current stream state. The cached image may be used to resume the stream when the user elects to do so by interacting with the link or initiating the stream in any manner as discussed above.

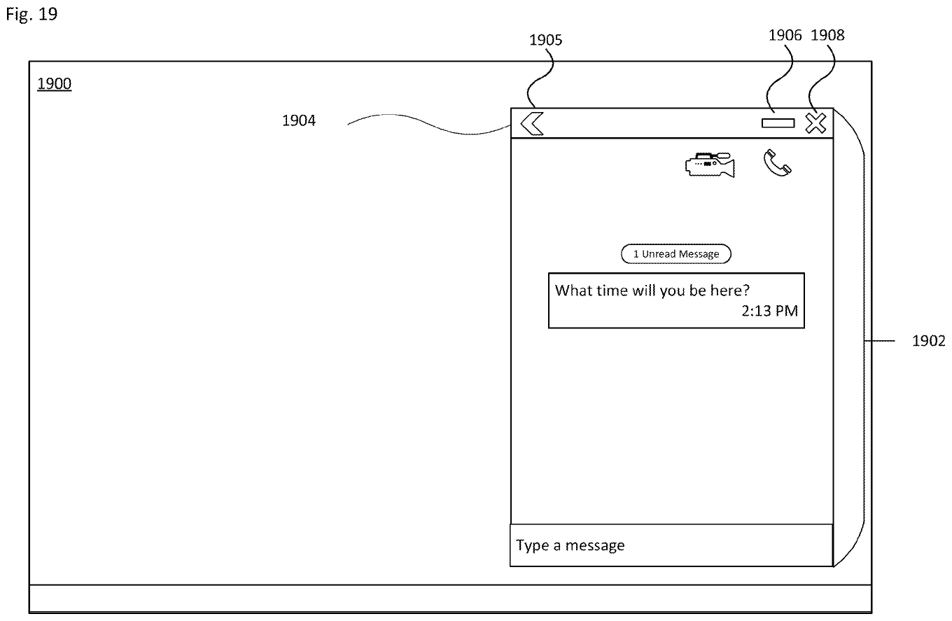

In another example, a stream may be closed by a user selecting the currently streamed app in apps selection 1204 or apps list 1250. Selecting apps selection 1204 or apps list 1250 may stop the stream on the computing device and may transfer the app content to a main display of the mobile device, allowing the user to resume use of the app on the mobile device from the point the user closed the stream on the computing device. In a further example, the user may close the stream from the stream itself. FIG. 19 illustrates a computing device display 1900 with an open stream 1902 and streamed app taskbar 1904. The virtualized remote display 1902 contains a back button 1905, a minimize control 1906, and a close control 1908. The back button 1905 may end the stream and return to the apps list and/or the app selection screen. The minimize control 1906 may minimize the app stream while still maintaining an active stream while the close control 1908 may terminate the app stream. A minimized app stream may remain minimized for a period of time (e.g., 10 minutes, or more, or less) and after which, the stream may automatically terminate. In another example, a stream may close due to certain errors such as when the computing device and the mobile device are no longer in range. Stream closure due to errors is discussed in further detail below.

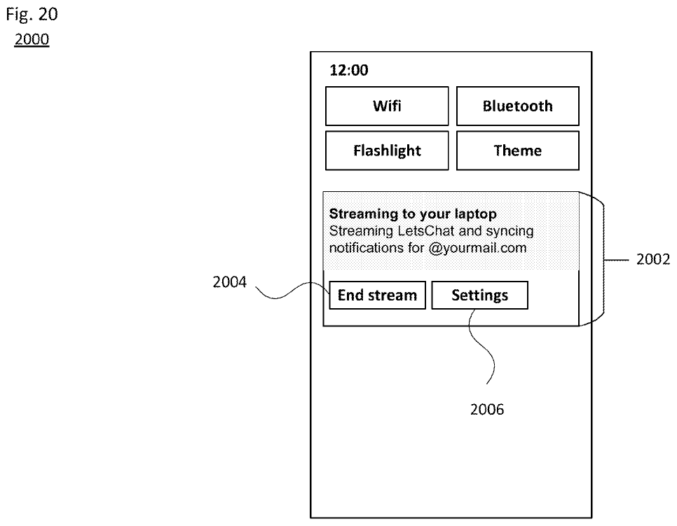

In an additional example, the stream may be closed from the mobile device through a silent, persistent notification 2002 as illustrated in example 2000 of FIG. 20. While the app is streaming to the computing device, the mobile device may display the persistent notification 2002 informing the user an application is currently being streamed. The notification 2002 may be located anywhere on the GUI of the mobile device. The notification 2002 may contain an end stream control 2004 and a settings control 2006. A user may end the stream using the end stream control 2004. When a stream is ended, the app that was streamed may be added to the recent apps section. For instance, when the apps selection 1204 is a recent apps selection, an app may be added to the apps selection 1204 if closed from the computing device or the mobile device. In one example, opening an app at the computing device moves it to the front of the recent app stack on the mobile device's side. In another example, opening an instance of an app from the recent app stack on the mobile device may tear down any active streaming connection associated with that app. Here, stopping the stream may not close the app since it is actively being opened on the mobile device. However, closing an app stream on the computing device may make that app accessible at the front of the recent app stack on the mobile device.

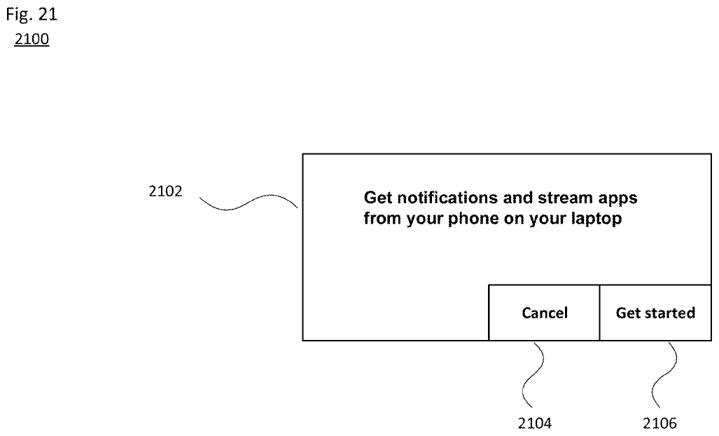

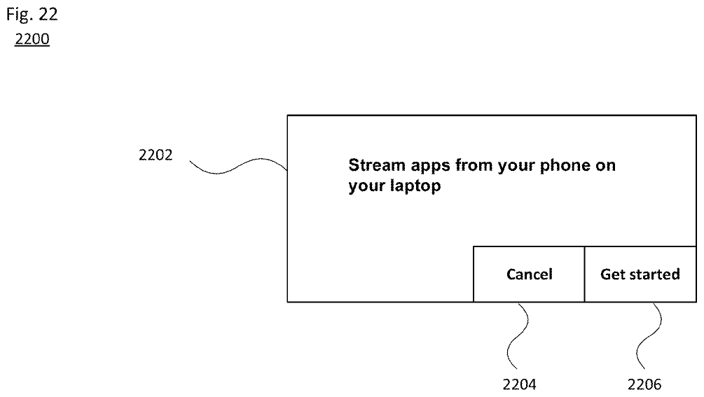

In some implementations, a prompt may be displayed on the computing device to induce a user to install, update, and/or input user information needed to stream apps. Differing messages may be generated depending on the status of the user. For example, a user may be a new user; an existing user, or an existing user with one or more new devices. In one implementation, as illustrated in example 2100 of FIG. 21, a new user may receive a notification 2102 to install software on their computing device capable of executing the methodology described herein and establish a user profile. The notification 2102 may include a link 2106 to begin the installation process and control 2104 to discontinue the installation process and remove the notification 2102. An existing user with one or more new devices may receive the same or similar message as a new user. As illustrated in view 2200 of FIG. 22, the user may receive a notification 2202 to update existing software on their computing device capable of executing the methodology described herein. The notification 2202 may also include a link 2206 to begin the installation process and control 2204 to discontinue the installation process and remove the notification 2202.

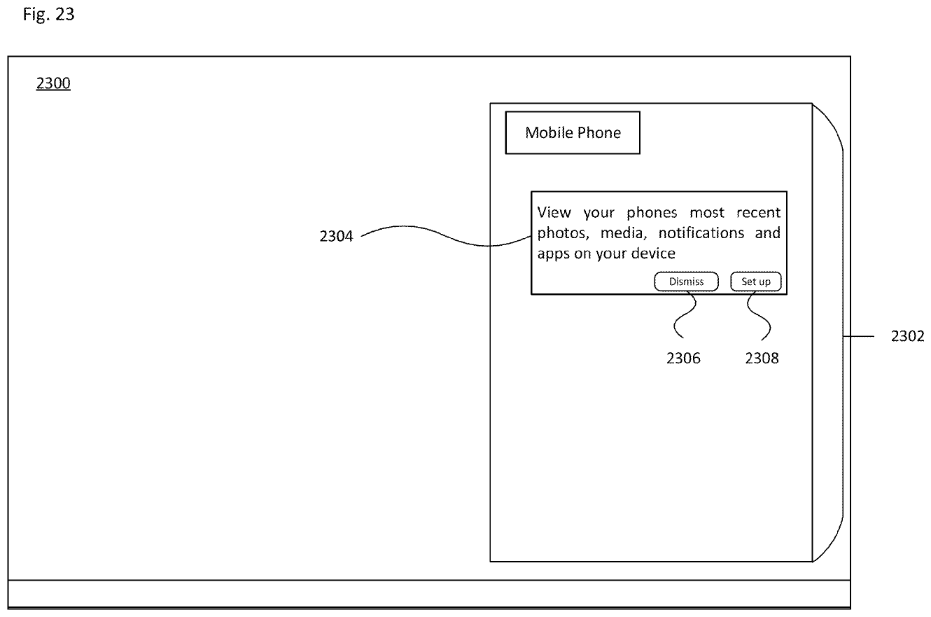

Alternatively, a user may be prompted to update current software through a mobile device interface 2302 on the display 2300 of the computing device. FIG. 23 shows the interface 2302 with prompt 2304 to update and/or install software. The prompt 2304 may contain a link 2308 to begin the installation process and control 2306 to discontinue the installation process and dismiss the notification.

In some implementations, the app may be a messaging app and a notification for such a messaging app may include a reply in-line feature. For example, as shown in view 2400 of FIG. 24, notification 2402 pertaining to a messaging app displays text and app information 2404. Notification 2402 also contains a reply in-line feature where a user may, without streaming an app, read message text 2404, input a reply into the text box 2406 using one or more user inputs, and send the reply using the send control 2408 using the one or more user inputs. In some implementations, the notification and stream may allow messages to be sent using specific inputs from the one or more user inputs. For example, a user may use the enter key (or other key) of a keyboard of the computing device to send a message. To do this the mobile device inputs may be mapped to the computing device inputs; meaning if when using the mobile device, pressing the enter key sends a message, this feature may be mapped to the computing device and similarly allowing the enter key to send messages.

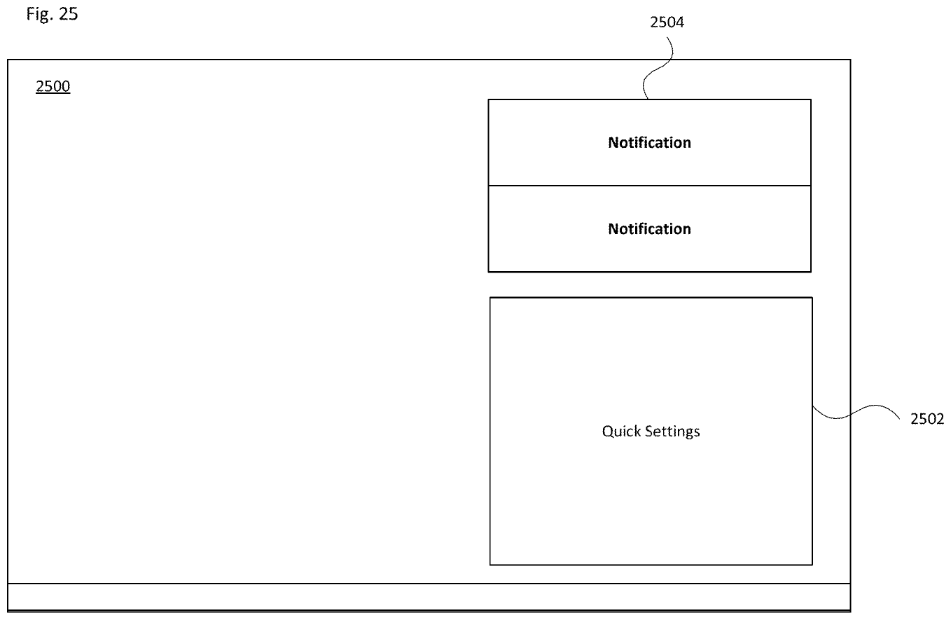

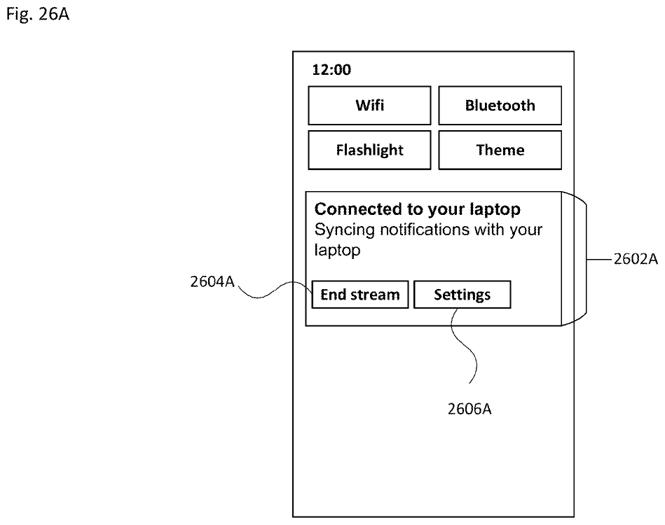

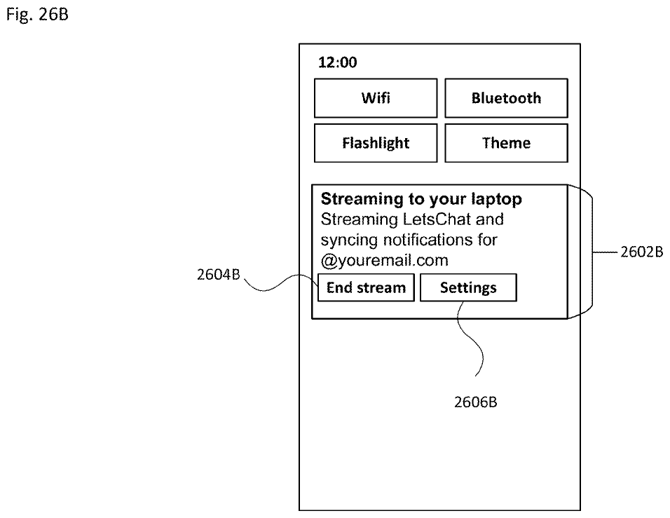

In some implementations, when a user does not engage with a notification (e.g., open a stream, reply in-line, or dismiss the notification) the notification may be accessed in a notification center. For example, in FIG. 25, a user may access a quick settings menu 2502 on the display 2500 of the computing device. The notification center 2504, containing one or more missed notifications, may be displayed with the quick settings menu 2502. In one scenario, only conversation notifications (e.g., a chat or text string) are mirrored on the computing device from the mobile device. By way of example, responding to a notification or dismissing it on the computing device clears that notification from the mobile device. Selecting (e.g., by tapping or clicking on) an app notification may open the streamed app, and may cause the app to be added to the recent apps list on the mobile device.

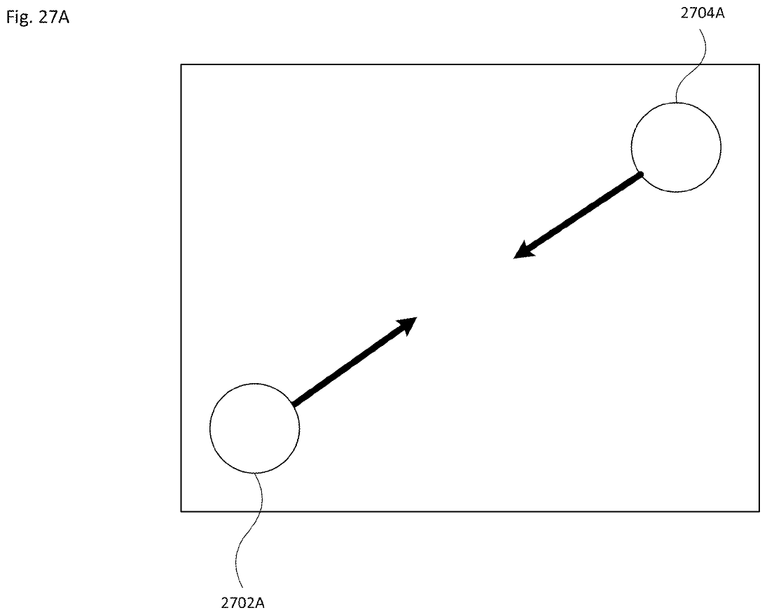

In some implementations, the mobile device generates a silent, persistent notification 2602 indicating the mobile device is connected to the computing device. For example, as in FIG. 26A, the persistent notification 2602A may allow a user to terminate the connection through a disconnect control 2604A. The persistent notification may also allow the user to access connection settings through a settings control 2606A. In some implementations the mobile device may generate a different silent, persistent notification 2602B when the mobile device is streaming to the computing device. FIG. 26B shows persistent notification 2602B. Persistent notification 2602B notifies a user the mobile device is currently streaming to the computing device and allows the user to terminate the stream through an end stream control 2604B and to access connection settings through a settings control 2606B. Additionally or alternatively, the silent, persistent notification may be a connection indicator, such as an icon to notify a user of the connection between the mobile device and the computing device. When streaming, the icon may additionally indicate an application is currently streaming. This may be done by, for example, including an icon of the streamed app. Such an indicator may be located anywhere on the display of the mobile device. Additionally, the indicator may be a light indicator located on the mobile device (e.g., an LED). Additionally or alternatively, there may be a plurality of indicators at differing locations.

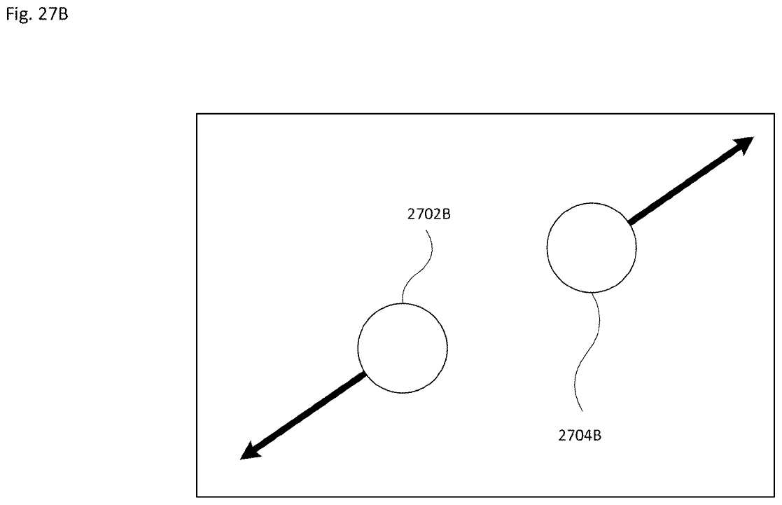

In some implementations, the computing device allows a user to use multi-touch interactions to magnify and reduce the displayed stream image. Multi-touch interactions may be supported on one or more user inputs such as a trackpad and a touchscreen. FIGS. 27A-B illustrate how a user may use multi-touch interactions. For example, to magnify, or zoom in, a user may contact the display with two fingers, the first finger at a first point 2702A and the second finger a second point 2704A. The user may then slide their fingers towards one another, across the user interface. To reduce, or zoom out, a user may contact the user interface with two fingers, the first finger at a first point 2702B and the second finger a second point 2704B. The user may then slide their fingers away from one another, across the user interface. In an example where the user interface is a trackpad, the stream may zoom in and/or zoom out at the location the cursor is currently located on the display of the computing device. In alternatives, magnifying and reducing may be performed using gestures or even voice instructions.

In some implementations, the system may be configured to address stream errors (e.g., a connectivity timeout), address content errors (e.g., playing content does not work), and maintain system health. In one example, when a stream is experiencing a long loading time (e.g., on the order of 10-30 seconds or more), the computing device may display a notification stating the mobile device is in the process of loading the stream and/or connecting to the computing device and advising a user to ensure the devices are connected to the network and ensure the mobile device is within range of the computing device. In another example, when the computing device and a mobile device fail to connect, a notification may inform the user of the failed connection, prompt the user to ensure the mobile and computing devices are connected to the network, and prompt the user to attempt connecting the devices again. The notification may additionally inform the user the computing device and mobile device are connected to differing networks, and prompt the user to connect the computing device and the mobile device to the same network. Additionally or alternatively, the notification may inform the user a network is not supported (e.g., unable to be used to stream) and may prompt the user to use a differing network to stream. The notification may additionally direct the user to seek assistance. In a further example, when an application is not supported (e.g., unable to be streamed) a notification may inform the user by displaying messages such as “Not supported”, “Not supported by app”, or “Can't stream app”. In this regard, a different displayed notification may be generated based on the reason the application is not supported (e.g., security, technical limitations, developer opt out, etc.). In an additional example, when a connection over the network is weak causing a stream to be slowed (e.g., reduced quality), a notification may inform a user the stream may be slow.

Similarly, during device pairing, if the computing device and a mobile device fail to pair, a prompt (at one or both devices) may inform the user of the failed pairing and prompt the user to learn more about potential issues. The prompt may also allow the user to exit the pairing process. In another example, when the connection between the computing device and the mobile device is lost, a notification may inform the user of the lost connection, prompt the user to ensure the mobile and computing devices are connected to the network, and prompt the user to attempt connecting the devices again. In an additional example, when a stream or notification fails to launch, a notification may inform the user of the failure to launch. In another example, when an application does not support application streaming and thus is unable to load a stream, a notification may inform the user. In such an implementation, the computing device may still generate mirrored notifications for the application. In an additional example, when an unknown error prevents streaming, a general error message may be displayed to the reader via a notification.

As discussed above, during the pairing process, a user may be prompted to accept permissions as illustrated in FIGS. 10A-B. In some implementations, differing permissions are needed for application streaming and notification mirroring. For example, for notification mirroring, permission may be granted for photos and media and notifications. A message 1006A may be used to communicate the permissions needed and prompt the user to “Allow” 1002 such information to be accessed by the computing device. For application streaming, permission may be granted for applications. A message 1006B may be used to communicate the permissions needed and prompt the user to “Allow” 1002 such information to be accessed by the computing device. The user may revoke permissions at any point. If a user revokes permissions required to receive notifications and/or stream applications, a user may be prompted to again accept the revoked permissions.

In some implementations, the system verifies one or more lock screen settings prior to starting a stream. A mobile device or computing device has a lock screen enabled when a user may enter a pin or passcode to access the device when the device goes to sleep, is powered down, or is locked. When a mobile device does not have a lock screen enabled, the computing device may begin streaming when prompted to do so. When a mobile device and the computing device both have lock screens enabled, the computing device may begin streaming when prompted to do so. When the mobile device has a lock screen enabled, but the computing device does not, streaming may not begin, and a notification may be presented to the user prompting the user to enable a lock screen for the computing device.

In some implementations, a computing device may stream an application capable of making and receiving video calls and/or audio calls. The call may be maintained while the stream is open on the computing device. If a user attempts to close the stream during the call, the user may receive a notification informing them if the stream is closed, the call may be terminated. The notification may allow the user to close the stream, or to cancel closing the stream and continue the call.

Alternatively or additionally, in some implementations, an active stream may allow a user to import and export information to and from the computing device. In one example, a user may copy and paste text, images, etc. between the stream from the mobile device and the computing device. An input on the computing device via the one or more user inputs triggers the mobile device to send additional information containing the material to be copied and/or pasted over the network. In another example, a user may interact with a link to a webpage. In such an example, the user may interact with the link in the stream via one or more user interfaces. In response, the mobile device sends the link information over the network, allowing the webpage to be loaded on the computing device. In some scenarios, the webpage may require signing into a user account to access the page. If the mobile device contains user credentials for the webpage, it may send the credentials to the computing device in addition to the link information.

Alternatively or additionally, in some implementations, the system may be configured to switch a connection of an audio output between the mobile device and the computing device to facilitate audio stability during app streaming. Audio switching may be triggered by an application stream containing audio and an audio output, such as a headset, connected to the network via the computing device or the mobile device. When the audio output connected to the network switches from one device to the other, a notification may be generated informing the user of the switch. In one example, if a headset may be connected to the computing device and an initiated stream contains audio, the headset connection may switch to the mobile device while the application is streamed to the computing device. The stream audio may be output to the headset through the mobile device and audio to the computing device may be suspended while the headset remains connected to the mobile device. In another example, if a headset may be connected to the mobile device and an initiated stream contains audio, the headset connection may remain with the computing device while the application is streamed to the computing device. In such an example, audio from the stream may be output from the headset via the computing device.

In one implementation the connection of the audio output may not be switched between the computing device and the mobile device. For example, if a headset is connected to the mobile device and an initiated stream contains audio, the headset connection may remain with the mobile device while the application is streamed to the computing device. The stream audio may be output to the headset through the mobile device and audio to the computing device may be suspended while the headset remains connected to the mobile device. In another example, if a headset is connected to the computing device and an initiated stream contains audio, the headset connection may remain with the computing device while the application is streamed to the computing device. In such an example, audio from the stream may be output from the headset via the computing device.

In addition or alternative to the above examples and scenarios, the external device app streaming process may support camera, microphone, and/or speaker use at the computing device and provide captured information to the mobile device. This may be beneficial for certain apps such as messaging apps and videoconference apps. Also, copy/paste events can be supported by the virtualized remote display, enabling the user to perform those actions at the computing device and sending the information back to the mobile device. Furthermore, the technology can support native handoff involving filtering down to different notifications. Here, for example, when the user gets a notification that includes a reply field, the system may use that as a signal to indicate it is associated with a messaging app, so that the notification can be selectively shown on the computing device. By way of example, the system may pass information indicating that there is a chat message for the user, while also passing over metadata and user credentials to the other device. In this way, the other device (e.g., the computing device), can act on the message via its own version of the app without having to go through the streaming approach. Or, in another example, a hyperlink may be provided in a chat message, and the user may be able to open that link directly in a browser of the computing device.

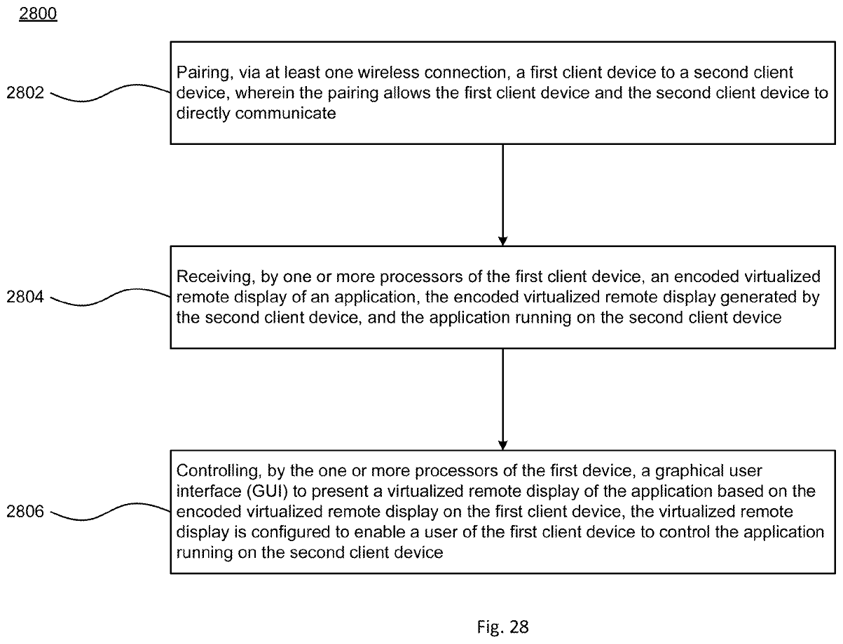

FIG. 28 illustrates an example method 2800. As shown in block 2802, the method includes pairing, via at least one wireless connection, a first client device to a second client device, wherein the pairing allows the first client device and the second client device to directly communicate. At block 2804, the method includes receiving, by one or more processors of the first client device, an encoded virtualized remote display of an application, the encoded virtualized remote display generated by the second client device, and the application running on the second client device. And at block 2806, the method includes controlling, by the one or more processors of the first device, a graphical user interface (GUI) to present a virtualized remote display of the application based on the encoded virtualized remote display on the first client device, the virtualized remote display is configured to enable a user of the first client device to control the application running on the second client device.

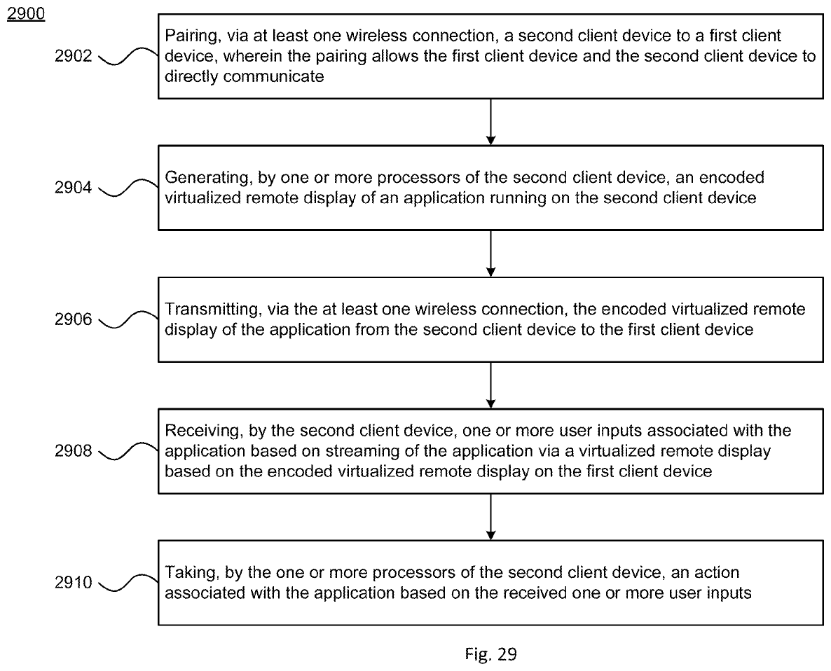

FIG. 29 illustrates an example method 2900 for application streaming. As shown in block 2902, pairing, via at least one wireless connection, a second client device to a first client device, wherein the pairing allows the first client device and the second client device to directly communicate. At block 2904, the method includes generating, by one or more processors of the second client device, an encoded virtualized remote display of an application running on the second client device. At block 2906, the method includes transmitting, via the at least one wireless connection, the encoded virtualized remote display of the application from the second client device to the first client device. At block 2908, the method includes receiving, by the second client device, one or more user inputs associated with the application based on streaming of the application via a virtualized remote display based on the encoded virtualized remote display on the first client device. And at block 2910, the method includes taking, by the one or more processors of the second client device, an action associated with the application based on the received one or more user inputs.

While certain examples herein refer to a computing device and a mobile device performing certain operations, the technology may be used with different types of client devices, and is not limited to the specific types of devices identified in the examples.

Although the technology herein has been described with reference to particular implementations, it is to be understood that these implementations are merely illustrative of the principles and applications of the present technology. It is therefore to be understood that numerous modifications may be made to the illustrative implementations and that other arrangements may be devised without departing from the spirit and scope of the present technology as defined by the appended claims.

1. A method, comprising:
pairing, via at least one wireless connection, a first client device to a second client device, wherein the pairing allows the first client device and the second client device to directly communicate;
receiving, by one or more processors of the first client device, an encoded virtualized remote display of an application via streaming from the second client device, the encoded virtualized remote display generated by the second client device, the application running on the second client device; and
controlling, by the one or more processors of the first device, a graphical user interface (GUI) to present a virtualized remote display of the application based on the encoded virtualized remote display on the first client device, the virtualized remote display configured to enable a user of the first client device to control the application running on the second client device.

2. The method of claim 1, further comprising:
receiving, by the first client device, an indication for an event associated with the application running on the second client device; and
generating, by the one or more processors of the first client device for presentation via the GUI based on the received indication, a notification regarding the event.

3. The method of claim 2, wherein the notification is actionable by the user of the first client device such that upon receiving input from the user, the method further includes transmitting a signal to the second client device, the signal configured to cause the second client device to perform an action associated with the application.

4. The method of claim 1, further comprising:
upon termination of the streaming of the application, causing an image of the virtualized remote display of the application to be cached.

5. The method of claim 4, further comprising:
designating, upon termination of the streaming of the application, the application as one of a set of one or more recent applications; and
generating, for presentation by the GUI of the first client device, a menu of the one or more recent applications.

6. The method of claim 4, further comprising the one or more processors of the first client device sending a signal to the second client device to terminate the stream upon determining that the first client device is no longer paired with the second client device.

7. The method of claim 1, further comprising:
causing, when the at least one wireless connection is not maintained, termination of the streaming after a period of time;
re-establishing the at least one wireless connection between the first client device and the second client device; and
causing resuming of the streaming following the re-establishing of the at least one wireless connection.

8. The method of claim 1, further comprising generating, via the GUI of the first client device, at least one of, an icon indicating the second client device and the first client device are paired, or an icon indicating the streaming of the application is occurring.

9. The method of claim 1, wherein:
the at least one wireless connection includes a first wireless connection and a second wireless connection distinct from the first wireless connection;
the pairing occurs via the first wireless connection; and
receiving the virtualized remote display of an application via streaming occurs via the second wireless connection.

10. The method of claim 9, further comprising transmitting, by the first client device, one or more user inputs received in response to the virtualized remote display, to the second client device via the second wireless connection.

11. The method of claim 1, wherein receiving the encoded virtualized remote display of the application via streaming includes decoding, by the one or more processors of the first client device, the encoded virtualized remote display of the application.

12. The method of claim 1, further comprising generating, via the GUI of the first client device, at least one prompt to facilitate pairing between the first client device and the second client device.

13. An application streaming method, comprising:
pairing, via at least one wireless connection, a second client device to a first client device, wherein the pairing allows the first client device and the second client device to directly communicate;
generating, by one or more processors of the second client device, an encoded virtualized remote display of an application running on the second client device;
transmitting, via the at least one wireless connection, the encoded virtualized remote display of the application from the second client device to the first client device via streaming;
receiving, by the second client device, one or more user inputs associated with the application based on presentation of the application via a virtualized remote display based on the encoded virtualized display on the first client device; and
taking, by the one or more processors of the second client device, an action associated with the application based on the received one or more user inputs.

14. The method of claim 13, further comprising, prior to the transmitting, the one or more processors of the second client device encoding the virtualized remote display of the application.

15. The method of claim 13, wherein taking the action associated with the application includes updating the encoded virtualized remote display of the application.

16. The method of claim 13, further comprising generating, by the one or more processors of the second client device, a graphical user interface (GUI) that includes at least one of a permissions prompt to facilitate the pairing, or an actual display of the application for presentation to a user.

17. The method of claim 16, wherein the virtualized remote display generated by the one or more processors of the second client device has a different visual appearance than the actual display of the application.

18. The method of claim 13, wherein the encoded virtualized remote display is generated by the one or more processors of the second client device when a display device of the second client device is in a sleep mode.

19. The method of claim 13, wherein the encoded virtualized remote display is generated by the one or more processors of the second client device while another application is presented on a display device of the second client device.

20. The method of claim 13, further comprising, in response to termination of the streaming, the one or more processors of the second client device caching an image of the virtualized remote display of the application.

21. The method of claim 13, wherein:
the at least one wireless connection includes a first wireless connection and a second wireless connection distinct from the first wireless connection;
the pairing occurs via the first wireless connection; and
transmitting of the encoded virtualized remote display of the application from the second client device occurs via the second wireless connection.

22. A computing device configured to stream applications from a remote device, the computing device comprising:
one or more processors;
one or more user inputs operatively coupled to the one or more processors; and
a communication module operatively coupled to the one or more processors, the communication module being configured to:
facilitate pairing of the computing device with the remote device via at least one wireless connection, wherein the pairing allows the computing device and the remote device to directly communicate, and
receive, via a stream, an encoded virtualized remote display of an application from the remote device, the application being run on the remote device,
wherein the one or more processors are configured to:
generate a graphical user interface (GUI) to present the application, including presentation on the GUI a virtualized remote display, based on the encoded virtualized remote display, of the application being run on the remote device;
receive input associated with the virtualized remote display from the one or more user inputs; and
transmit, via the communication module, information regarding the received input to the remote device in order to control the application on the remote device.

23. A computing device configured to stream applications to a remote device, the computing device comprising:
one or more processors;
one or more user inputs operatively coupled to the one or more processors; and
a communication module operatively coupled to the one or more processors, the communication module being configured to:
facilitate pairing of the computing device with the remote device via at least one wireless connection, wherein the pairing allows the computing device and the remote device to directly communicate, and
wherein the one or more processors are configured to:
generate an encoded virtualized remote display of an application of the computing device, the application being run on the computing device;
cause the communication module to transmit, via the at least one wireless connection, the encoded virtualized remote display of the application to the remote device via streaming;
receive, from the remote device via the communication module, one or more user inputs associated with the application based on presentation of virtualized remote display, based on the encoded virtualized remote display, of the application on the remote device; and
take an action associated with the application based on the received one or more user inputs.
